(19) United States
(12) Patent Application Publication
(10) Pub. No.: US 2025/0238050 A1
(43) Pub. Date: Jul. 24, 2025

(54) REGULATOR APPARATUS AND COOKING APPARATUS INCLUDING SAME

(71) Applicant: SAMSUNG ELECTRONICS CO., LTD., Suwon-si (KR)

(72) Inventors: Geunyong PARK, Suwon-si (KR); Sungsoo PARK, Suwon-si (KR); Jangmuk CHOI, Suwon-si (KR); Cheoleun CHOI, Suwon-si (KR)

(73) Assignee: SAMSUNG ELECTRONICS CO., LTD., Suwon-si (KR)

(21) Appl. No.: 19/175,557

(22) Filed: Apr. 10, 2025

Related U.S. Application Data
(63) Continuation of application No. PCT/KR2023/014255, filed on Sep. 20, 2023.

(30) Foreign Application Priority Data
Oct. 28, 2022 (KR) 10-2022-0141801
Dec. 27, 2022 (KR) 10-2022-0186484

(51) Int. Cl. G05G 1/08; G05G 5/00; G05G 5/05

(52) U.S. Cl. CPC G05G 1/082; G05G 5/005; G05G 5/05; G05G 2505/00

(57) ABSTRACT

A cooking apparatus including a case having a stopper groove; a shaft including a shaft body having at least partially insertable into the case; a cam arrangeable to be adjacent to the shaft so that the shaft is insertable into the cam. The cam is configured to, while the shaft is in a second position, rotate with the shaft so that the regulator apparatus detects the user input; and an operation prevention member to be located between the cam and the stopper groove. While the shaft is in the operation prevention position, in order to prevent rotation of the cam due to the shaft, the stopper is located inside the operation prevention member so as to prevent the shaft from moving from the operation prevention position to the second position.

### CROSS-REFERENCE TO RELATED APPLICATION

This application is a continuation application is a continuation application, under 35 U.S.C. § 111(a), of international application No. PCT/KR2023/014255, filed Sep. 20, 2023, which claims priority under 35 U. S. C. § 119 to Korean Patent Application No. 10-2022-0141801, filed Oct. 28, 2022, and Korean Patent Application No. 10-2022-0186484, filed Dec. 27, 2022, the disclosures of which are incorporated herein by reference in their entireties.

### TECHNICAL FIELD

The present disclosure relates to a cooking apparatus, and more particularly, to a cooking apparatus including a regulator apparatus.

### BACKGROUND ART

In general, a cooking apparatus is a home appliance that cooks food by including a cooking room, a heating device for applying heat to the cooking room, and a circulation device for circulating heat generated in the heating device inside the cooking room. The cooking apparatus is a mechanism that seals, heats, and cooks food, and is generally classified into an electric type, a gas type, and an electronic type according to a heat source of the heating device. For example, an electric oven uses heat from a heater operating by electricity as a heating source, a gas oven uses heat generated by a gas as a heating source, and a microwave uses friction heat of water molecules caused by high-frequency waves, as a heat source.

The cooking apparatus includes a control panel at any one of the front and upper surfaces of the main body. On the control panel, a plurality of buttons, a keypad, and/or a knob assembly that enables a user to set his/her desired cooking mode or various conditions for cooking are provided.

A regulator apparatus that controls the heating device operates in a push and turn type. The knob assembly for operating the regulator apparatus controls operations of the cooking apparatus by a two-step mechanism of pressing a regulating shaft of the regulator apparatus by being pressed and then rotating.

Meanwhile, when a user unintentionally operates the knob assembly, fire or burns may be caused.

### DISCLOSURE

### Technical Problem

An aspect of the present disclosure provides a regulator apparatus capable of preventing a malfunction and a cooking apparatus including the regulator apparatus.

An aspect of the present disclosure provides a regulator apparatus capable of preventing a malfunction in a push motion and a cooking apparatus including the regulator apparatus.

An aspect of the present disclosure provides a regulator apparatus capable of preventing an input signal from being generated while a force is applied to a knob in another direction than a vertical direction to push a shaft connected to the knob, and a cooking apparatus including the regulator apparatus.

An aspect of the present disclosure provides a regulator apparatus capable of causing a shaft to idle without rotating to rotate a cam that carries electricity to an electrode while a force is applied to a knob in a direction in which a malfunction may occur to push the shaft connected to the knob, and a cooking apparatus including the regulator apparatus.

The technical objects intended to be achieved by the present document is not limited to the above-mentioned technical objects, and other technical objects not mentioned will be clearly understood by one of ordinary skill in the technical art to which the disclosure belongs from the following description.

### Technical Solution

To resolve the problem, a cooking apparatus according to a concept of the present disclosure may include a heating source, and a regulator apparatus configured to detect a user input for operating the heating source. The regulator apparatus may include a case including a stopper groove, a shaft including a shaft body having at least a part is insertable in the case, the shaft including a stopper protruding from the shaft body and configured to be accommodated in the stopper groove while the shaft is inserted in the case and located at a first position. The stopper may be movable to a second position spaced an operation distance from the stopper groove and an operation prevention position spaced an operation prevention distance from the stopper groove, the operation prevention distance being shorter than the operation distance. The regulator apparatus may include a cam arrangeable adjacent to the shaft such that the shaft is insertable into the cam, the cam configured to rotate together with the shaft while the shaft is inserted into the cam and the shaft is at the second position, thereby enabling the regulator apparatus to detect the user input, and an operation prevention member located between the cam and the stopper groove. While the shaft is at the operation prevention position, the stopper is located on an inner side of the operation prevention member to prevent the shaft from moving from the operation prevention position to the second position in order to prevent the cam from rotating by the shaft.

The operation prevention member may include a stopper hole which the stopper penetrates to allow the shaft to move from the operation prevention position to the second position.

The case may include a case cover in which the stopper groove is located, the operation prevention member may include a stopper plate spaced from the case cover to form an operation prevention space, and the stopper may be located in the operation prevention space while the shaft is at the operation prevention position.

The stopper may be configured to spin around a rotation axis of the shaft inside the operation prevention space while the shaft is at the operation prevention position.

The cam may be configured to, while the shaft is at the operation prevention position, be prevented from rotating together with the shaft to prevent the regulator apparatus to detect the user input, and the stopper plate may include a stopper hole which the stopper penetrates to allow the shaft to move from the operation prevention position to the second position, and while the shaft rotates about the rotation axis while at the operation prevention position, the stopper may be misaligned with a position corresponding to the stopper hole and come into contact with the stopper plate to prevent the shaft from moving to the second position.

The stopper hole may be aligned with the stopper groove in a direction that is parallel to the rotation axis of the shaft, and a cross sectional area of the stopper hole may be larger than a cross sectional area of the stopper groove allowing the stopper to penetrate the stopper hole while the shaft rotates about the rotation axis while the shaft moves from the first position toward the second position.

The cooking apparatus may further include a processor configured to control the heating source such that the heating source operates based on a user input detected by the regulator apparatus, wherein the cam may include a pressing rib extending in a circumferential direction around a rotation axis of the cam, and the regulator apparatus may include a first terminal of which at least a part is movable by being pressed by the pressing rib while the cam rotates, and a second terminal configured to carry electricity by contacting the first terminal moved to enable the regulator apparatus to detect the user input.

The shaft may further include a shaft flange protruding in a radial direction from the shaft body and configured to contact the stopper plate while the shaft moves from the second position toward the first position, thereby preventing the shaft from departing from the case.

The stopper may be spaced from the shaft flange to form a plate accommodating space between the stopper and the shaft flange, and the stopper plate may be accommodated in the stopper accommodating space while the shaft is at the operation prevention position and the stopper spins, thereby being prevented from interfering with a rotation of the shaft.

The shaft may include a cylindrical portion located at an end toward the cam and configured to be accommodated in the cam in such a way as to rotate independently from the cam while the shaft is at the operation prevention position.

The shaft may include a rotation prevention portion being adjacent to the cylindrical portion and being rotationally asymmetrical to the rotation axis of the shaft, and the rotation prevention portion may be accommodated in the cam while the shaft is at the second position to rotate together with the cam.

The cooking apparatus may further include an elastic member accommodated in the cam and configured to press the shaft in a direction from the second position toward the first position.

The cam may further include a cam body, a convex portion protruding from the cam body, a concave portion being concave from the cam body and defining a ticker accommodating groove, and a ticker located between the case and the cam, being accommodable in the ticker accommodating groove, and contacting the convex portion according to a rotation of the cam to generate vibration according to the rotation of the cam.

The operation prevention member may include a stopper plate located adjacent to the stopper groove, the stopper plate including a stopper hole extending in a direction parallel to the rotation axis of the shaft and configured to accommodate the stopper while the shaft is at the operation prevention position.

The cooking apparatus may further include an elastic member located between the shaft and the cam and configured to press the shaft in the direction from the second position toward the first position, wherein a cross sectional area of the elastic member is reduced in the direction parallel to the rotation axis of the shaft such that the cam moves close to the operation prevention member according to compression of the elastic member.

A cooking apparatus according to a concept of the present disclosure may include a heating source and a regulator apparatus configured to generate an input signal by receiving a user input for operating the heating source. The regulator apparatus may include a case having a stopper groove, a shaft including a shaft body having at least a part insertable in the case, and a stopper protruding from the shaft body and configured to be accommodated in the stopper hole while the shaft is at a first position, wherein the stopper is movable to a second position spaced an operation distance from the stopper groove, and a cam arrangeable to be adjacent to the shaft such that the shaft is insertable into the cam, the cam configured to rotate together with the shaft to enable the regulator apparatus to detect the user input, wherein, while the shaft moves from the first position to the second position, the shaft may move outward from the case.

While the shaft is at the second position, the stopper may spin around a rotation axis of the shaft outside the case.

The case may include a case cover at which the stopper groove is located, and the shaft may further include a shaft flange protruding in a radial direction from the shaft body and configured to come into contact with the case cover while the shaft is at the second position, thereby preventing the shaft from departing from the case.

The stopper may be spaced from the shaft flange to define a plate accommodating space for accommodating the case cover between the stopper and the shaft flange while the shaft is at the second position and the stopper spins.

A regulator apparatus according to a concept of the present disclosure may include a case cover having a stopper groove, a shaft including a shaft body having at least a part insertable in the case cover and a stopper protruding from the shaft body and configured to be accommodated in the stopper groove while the shaft is located at a first position, wherein the stopper may be movable to a second position spaced an operation distance from the stopper groove and an operation prevention position spaced an operation prevention distance from the stopper groove, the operation prevention distance being shorter than the operation distance, a cam being arrangeable to be adjacent to the shaft such that the shaft is inserted in the cam, the cam configured to rotate together with the shaft while the shaft is at the second position to enable the regulator apparatus to detect a user input, and be prevented from rotating together with the shaft while the shaft is at the operation prevention position to prevent the regulator apparatus from detecting a user input, and a stopper plate spaced from the case cover to have an operation prevention space, the stopper plate configured to enable the stopper to spin inside the operation prevention space while the shaft is at the operation prevention position.

### Advantageous Effects

According to a concept of the present disclosure, a regulator apparatus and a cooking apparatus including the same may include a case having a stopper groove in which a stopper protruding from a shaft body is accommodable, and an operation prevention member having a second stopper to lengthen a push operation of a shaft, thereby preventing a malfunction of the regulator apparatus.

According to a concept of the present disclosure, a regulator apparatus and a cooking apparatus including the same may include an operation prevention member including a stopper plate that defines a second stopper to continuously accommodate a stopper in the second stopper while the stopper departs from the second stopper, thereby preventing a malfunction during a push operation.

According to a concept of the present disclosure, by including a stopper plate spaced from a case cover to define an operation prevention space in which a stopper is accommodatable between the case cover and the stopper plate and performs an orbital motion according to a rotation of a shaft, a regulator apparatus may be prevented from generating an input signal while a force is applied to a knob in another direction than a vertical direction to press the shaft connected to the knob.

According to a concept of the present disclosure, because a shaft includes a cylindrical portion that is rotatable independently from a cam while the cylindrical portion is accommodated in the cam, and a rotation prevention portion that rotates together with the cam while the rotation prevention portion is accommodated in the cam, while a force is applied to a knob in a direction in which a malfunction may occur to push a shaft connected to the knob, the shaft may idle without rotating to rotate the cam that carries electricity to an electrode.

Effects that may be achieved by the present disclosure are not limited to the above-mentioned effects, and other effects not mentioned will be clearly understood by one of ordinary skill in the technical field to which the disclosure belongs from the following descriptions.

### DESCRIPTION OF DRAWINGS

FIG. 1 is a perspective view of a cooking apparatus according to an embodiment of the present disclosure.

FIG. 2 is a front view of the cooking apparatus shown in FIG. 1 according to an embodiment of the present disclosure.

FIG. 3 is a cross-sectional view of the cooking apparatus shown in FIG. 1, taken along III-III′ according to an embodiment of the present disclosure.

FIG. 4 is an enlarged view of a portion of the cooking apparatus shown in FIG. 1, in which a knob assembly is positioned according to an embodiment of the present disclosure.

FIG. 5 is a perspective view of a regulator apparatus shown in FIG. 4 according to an embodiment of the present disclosure.

FIG. 6 is an exploded view of the regulator apparatus shown in FIG. 5 according to an embodiment of the present disclosure.

FIG. 7 is a rear exploded view of the regulator apparatus shown in FIG. 5 according to an embodiment of the present disclosure.

FIG. 8 is a cross-sectional view of the regulator apparatus shown in FIG. 5, taken along VIII-VIII′ according to an embodiment of the present disclosure.

FIG. 9 is a perspective view of a shaft shown in FIG. 8 according to an embodiment of the present disclosure.

FIG. 10 is a perspective view of an operation prevention member shown in FIG. 8 according to an embodiment of the present disclosure.

FIG. 11 is a cross-sectional perspective view of a cam shown in FIG. 8 according to an embodiment of the present disclosure.

FIG. 12 is a rear perspective view showing a rear side of the cam shown in FIG. 11 according to an embodiment of the present disclosure.

FIG. 13 is a cross-sectional perspective view of the regulator apparatus shown in FIG. 8 while a shaft of the regulator apparatus is pressed from a first position to a second position according to an embodiment of the present disclosure.

FIG. 14 is a cross-sectional perspective view of the regulator apparatus shown in FIG. 13 while the shaft of the regulator apparatus is pressed in an abnormal direction according to an embodiment of the present disclosure.

FIG. 15 is a cross-sectional perspective view of the regulator apparatus shown in FIG. 14 while the shaft of the regulator apparatus rotates in an operation prevention space according to an embodiment of the present disclosure.

FIG. 16 is a cross-sectional perspective view of the regulator apparatus shown in FIG. 13 while the shaft of the regulator apparatus is pressed from the second position to a third position according to an embodiment of the present disclosure.

FIG. 17 is a cross-sectional perspective view of the regulator apparatus shown in FIG. 16 while the shaft of the regulator apparatus rotates according to an embodiment of the present disclosure.

FIG. 18 is a cross-sectional perspective view of the regulator apparatus shown in FIG. 17 when a ticker comes into contact with a concave portion or a convex portion of a cam while the shaft of the regulator apparatus rotates according to an embodiment of the present disclosure.

FIG. 19 is a rear perspective view of the regulator apparatus shown in FIG. 18 when a first electrode is spaced apart from a second electrode while the shaft of the regulator apparatus rotates according to an embodiment of the present disclosure.

FIG. 20 is a rear perspective view of the regulator apparatus shown in FIG. 19 when the first electrode comes into contact with the second electrode while the shaft of the regulator apparatus rotates according to an embodiment of the present disclosure.

FIG. 21 is a cross-sectional perspective view of a regulator apparatus of a cooking apparatus according to an embodiment of the present disclosure.

FIG. 22 is a cross-sectional perspective view of a regulator apparatus of a cooking apparatus according to an embodiment of the present disclosure.

FIG. 23 is a cross-sectional perspective view of a regulator apparatus of a cooking apparatus according to an embodiment of the present disclosure.

FIG. 24 is a cross-sectional perspective view of a regulator apparatus of a cooking apparatus according to an embodiment of the present disclosure.

FIG. 25 is an exploded view of the regulator apparatus shown in FIG. 24 according to an embodiment of the present disclosure.

FIG. 26 is a cross-sectional perspective view of the regulator apparatus shown in FIG. 24 while a shaft of the regulator apparatus is pulled according to an embodiment of the present disclosure.

FIG. 27 is a cross-sectional perspective view of the regulator apparatus shown in FIG. 26 while the shaft of the regulator apparatus rotates according to an embodiment of the present disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Meanwhile, in the following description, the terms “vertical direction”, “lower”, “front-rear direction”, etc. are defined based on the drawings, and the shapes and positions of the components are not limited by the terms.

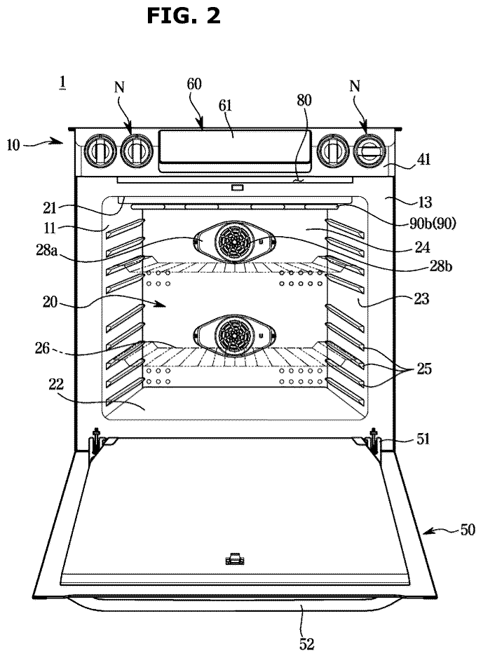

More specifically, as shown in FIG. 2, a direction in which a cooking room of a cooking apparatus opens may be defined as a front direction, and a rear direction, left and right sides, and upper and lower sides may be defined based on the front direction.

Also, a +X direction may be defined as a front direction, a +Y direction may be defined as a left direction, and a +Z direction may be defined as an up direction.

Hereinafter, embodiments of the present disclosure will be described in detail with reference to the accompanying drawings.

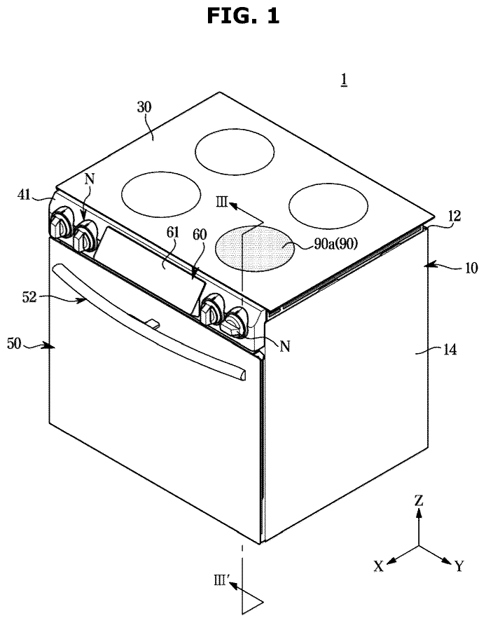

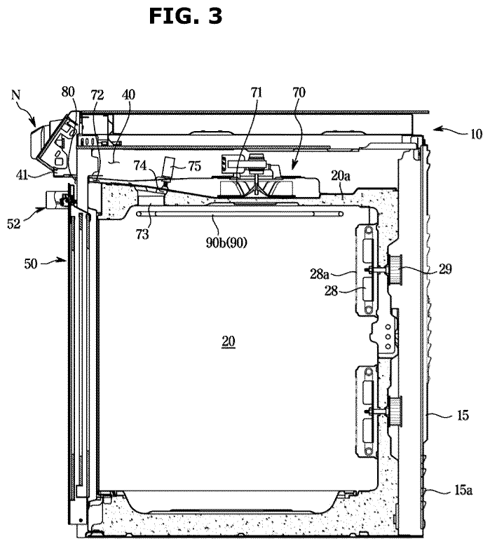

FIG. 1 is a perspective view of a cooking apparatus according to an embodiment of the present disclosure. FIG. 2 is a front view of the cooking apparatus shown in FIG. 1. FIG. 3 is a cross-sectional view of the cooking apparatus shown in FIG. 1, taken along III-III′.

Each of an inner case 11 and an outer case 12 may be substantially in a shape of a box of which a front side opens.

A cooking apparatus 1 may include a cooktop 30 which is provided on a top of the cooking apparatus 1 and on which a container containing food is placed and heated. The cooktop 30 may include at least one heating portion 90a. A container containing food may be placed within the heating portion 90a and directly heated.

The cooking apparatus 1 may include a door 50 provided on a front side of a main body 10 and configured to open or close the cooking room 20.

The outer case 12 may include a front panel 13 forming a front surface of the main body 10, a side panel 14 forming a side surface of the main body, and a rear panel 15 forming a rear surface of the main body 10.

In the front panel 13, an opening may be provided, and the cooking room 20 formed inside the main body 10 may open at the front side by the opening. The outer case 12 may include a control panel 41 that is positioned in an upper portion of the front panel 13 and covers a front side of a machine room 40. A display module 60 may be installed on the control panel 41.

The control panel 41 may be positioned on at least a portion of the main body 10. According to an embodiment of the present disclosure, the control panel 41 may be positioned on a side of the front surface of the main body 10, although not limited thereto. However, the control panel 41 may be positioned on an upper surface of the main body 10 or may form a surface of the main body 10.

In the rear panel 15, an inlet 15a through which air is sucked into the machine room 40 may be provided. Air sucked into the machine room 40 through the inlet 15a may flow inside the machine room 40 to cool electrical components. However, a location of the inlet 15a is not limited thereto, and the inlet 15a may be positioned at any location of sucking outside air and guiding the outside air to the machine room 40.

The cooking room 20 may be formed by an upper plate 21, a bottom plate 22, both side plates 23, and a rear plate 24. The cooking room 20 may be a cooking space and open at the front side through the opening of the front panel 13 to allow food to be put in and taken out.

On inner surfaces of the both side plates 23, a plurality of supports 25 may be provided. At least one rack 26 on which food may be placed and which is attachable onto the plurality of supports 25 may be installed on the plurality of supports 25.

On the plurality of supports 25, a rail (not shown) on which the rack 26 slides may be installed. A user may move the rack 26 through the rail (not shown) to take food out or place food.

On the plurality of supports 25, a divider (not shown) that divides the cooking room 20 into a plurality of cooking rooms 20 may be detachably installed. The plurality of cooking rooms 20 divided by the divider may not necessarily have the same size and may have different sizes.

Therefore, a user may use the plurality of cooking rooms 20 variously according to his/her intention. The divider may be made of an insulating material and insulate the cooking rooms 20 from each other.

In the cooking room 20, a heater 90b for heating food may be provided. The heater 90b may be an electric heater including an electric resistance member. However, the heater 90b is not limited thereto, and may be a gas heater that generates heat by burning gas. That is, the cooking apparatus 1 may include an electric oven and a gas oven.

The cooking apparatus 1 may include a heating source 90. The heating source 90 may be a component configured to heat a cooking material.

The heating source 90 may include the heating portion 90a and the heater 90b, mentioned above.

In the rear plate 24 of the cooking room 20, a circulation fan 28 that circulates air of the cooking room 20 to evenly heat food, and a circulation motor 29 that drives the circulation fan 28 may be provided.

A fan cover 28a for covering the circulation fan 28 may be provided in front of the circulation fan 28, and a vent hole 28b may be formed in the fan cover 28a to allow air to flow.

The open front side of the cooking room 20 may be opened or closed by the door 50, and the door 50 may be coupled to the main body 10 by a hinge 51 provided in a lower portion of the main body 10 in such a way as to rotate with respect to the main body 10.

In a front upper portion of the door 50, a handle 52 that is gripped by a user may be provided for the door 50 to open or close the cooking room 20.

A display module 60 that displays various operation information of the cooking apparatus 1 and enables a user to input an operation command may be installed in the control panel 41 provided on the front upper portion of the front panel 13.

The display module 60 may include a liquid crystal display (LCD), and the LCD may display electrical information being a change of liquid crystal transmittance according to an applied voltage as visual information. The LCD may include a liquid crystal module for displaying images and a light source unit for radiating light to the liquid crystal module. The light source unit may be a light emitting diode (LED).

The display module 60 may include a cover panel 61 positioned on a front surface of the LCD. The cover panel 61 may be a protective panel for protecting the LCD or a touch panel capable of receiving a user's touch commands.

In the control panel 41, a knob assembly N for operating the cooking apparatus 1 may be provided. According to an embodiment of the present disclosure, four knob assemblies N may be provided, although not limited thereto. The knob assembly N will be described in detail, below.

An insulating material 20a for insulating the machine room 40 and the cooking room 20 may be positioned between the machine room 40 and the cooking room 20 to prevent hot air of the cooking room 20 from being transferred to the machine room 40.

The insulating material 20a may surround an entire outer side of the cooking room 20, as well as between the machine room 40 and the cooking room 20, to prevent hot air of the cooking room 20 from being transferred to outside of the cooking apparatus 1.

Because an inside temperature of the machine room 40 may rise by heat from various electrical components, a blower 70 for circulating air around the machine room 40 to cool the machine room 40 may be provided in the cooking apparatus 1.

The blower 70 may include a blow fan 71 for moving air, and a discharge flow path 72 for discharging air sucked by the blow fan 71 in a front direction of the cooking apparatus 1.

The blow fan 71 may suck air in an axial direction and then discharge the air in a radial direction. That is, the blow fan 71 according to the disclosure may be a centrifugal fan. However, the blow fan 71 may include an axial flow fan.

Outside air may be sucked into the machine room 40 through the inlet 15a formed in the rear panel 15, and the air sucked into the machine room 40 may flow inside the machine room 40 to cool the electrical components and then flow along the discharge flow path 72 to be discharged in the front direction of the cooking apparatus 1 through an outlet 80.

The outlet 80 may include a space between the front panel 13 and the control panel 41, although not limited thereto. However, the outlet 80 may be positioned at various locations and have various shapes, as long as the outlet 80 allows air sucked through the inlet 15a to be discharged to the outside of the main body 10.

A part of inside air of the cooking room 20 may be sucked into the discharge flow path 72 through a cooking room flow path 73 and discharged to the front side of the cooking apparatus 1.

In the discharge flow path 72, a bypass hole 74 for allowing a part of air flowing from the discharge flow path 72 to the outlet 80 to flow to the cooking room flow path 73 may be formed, and the bypass hole 74 may be opened or closed by an opening and closing device 75.

While the bypass hole 74 is opened and closed by the opening and closing device 75, an amount of air entering the cooking room flow path 73 among air flowing from the discharge flow path 72 to the outlet 80 may be adjusted. Therefore, an emission amount of air that is discharged from the cooking room 20 to the cooking room flow path 73 may be adjusted.

The door 50 rotatably coupled to the front side of the main body 10 to open or close the cooking room 20 may include a plurality of glasses. A space may be formed between the plurality of glasses, and outside air may enter the space and circulate in the space to radiate heat of the door 50.

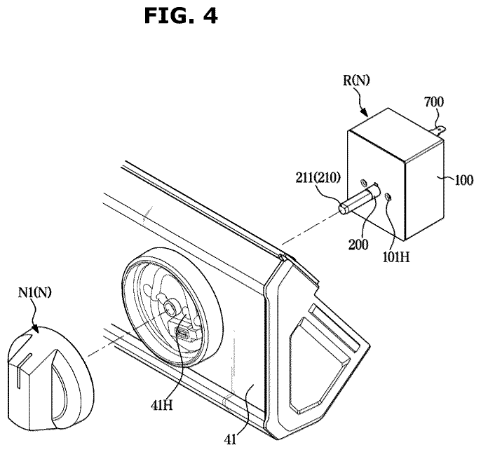

FIG. 4 is an enlarged view of a portion of the cooking apparatus 1 shown in FIG. 1, in which the knob assembly N is positioned.

The knob assembly N according to an embodiment of the present disclosure will be described with reference to FIG. 4.

The cooking apparatus 1 may include the knob assembly. The knob assembly N may be a component capable of receiving a user input for controlling the heating source 90 of the cooking apparatus 1.

The cooking apparatus 1 may include the control panel 41.

The knob assembly N may be coupled to the control panel 41.

The knob assembly N may include a knob N1 located at a side of the control panel 41. The knob N1 may be a component that is gripped by a user to allow the user to make a user input.

The knob N1 may be located in front of the control panel 41. Accordingly, the knob N1 may be exposed to a user.

The knob N1 may rotate relative to the control panel 41. The knob N1 may rotate about an axis. A user may make a user input by rotating the knob N1.

The knob N1 may have a portion having a substantially cylindrical shape. The portion of the knob N1, having the cylindrical shape, may be accommodated in the control panel 41. Therefore, the knob N1 may be rotatable.

The knob N1 may have a portion extending in one direction and protruding forward such that a user easily grips the portion. A user may rotate the knob N1 by gripping the portion of the knob N1 extending in one direction and protruding forward.

The knob N1 may include, but is not limited thereto, a plastic material.

The knob N1 may be formed by an injection molding process, although not limited thereto.

The knob N1 may have a shaft (200) installing hole. The shaft (200) installing hole may be a hole in which a shaft 200 of a regulator apparatus R which will be described below is inserted.

The shaft (200) installing hole may extend along the rotation axis of the knob N1.

The knob assembly N may include the regulator apparatus R. The regulator apparatus R may be a component that generates a signal according to a user input transferred from the knob N1.

The regulator apparatus R may detect a user input for operating the heating source 90.

The regulator apparatus R may be coupled to the knob N1. At least a portion of the regulator apparatus R may be positioned behind the control panel 41. Therefore, the regulator apparatus R may be prevented from being exposed to a user.

The refrigerant R may include a case 100. The case 100 may be a component that defines at least a portion of an appearance of the regulator apparatus R.

The case 100 may have a substantially rectangular parallelepiped shape.

The regulator apparatus R may include the shaft 200. The shaft 200 may be a component rotatably inserted in the case 100.

The shaft 200 may be coupled to the knob N1. While the knob N1 rotates, the shaft 200 may rotate together. The shaft 200 may be inserted in the shaft (200) installing hole. Accordingly, a user may rotate the knob N1, the rotation of the knob N1 may be transferred to the shaft 200, and while the shaft 200 rotates together, the regulator apparatus R may generate a signal.

The shaft 200 may extend along the rotation axis of the knob N1.

The shaft 200 may penetrate the control panel 41. A portion of the shaft 200 penetrated the control panel 41 and positioned in front of the control panel 41 may be coupled to the knob N1. Another portion of the shaft 200 positioned behind the control panel 41 may be coupled to the case 100.

The shaft 200 may include a shaft (200) body. The shaft (200) body may be a component that defines at least a portion of an appearance of the shaft 200.

The shaft (200) body may include a knob installing portion 211. The knob installing portion 211 may be a component coupled to the knob N1.

The knob installing portion 211 may be a rotationally asymmetrical component. The knob installing portion 211 may be accommodated in the shaft (200) installing hole. The shaft (200) installing hole may have a shape corresponding to the knob installing portion 211. Accordingly, the knob installing portion 211 may rotate together according to a rotation of the knob N1.

The case 100 may have a screw hole. The screw hole may be a hole into which a screw is installed.

The control panel 41 may have a panel screw hole 41H. The panel screw hole 41H may be a hole provided at a position corresponding to the screw hole.

A coupling member may couple the regulator apparatus R to the control panel 41 by penetrating the panel screw hole 41H and the screw hole.

Hereinafter, the regulator apparatus R will be described in more detail.

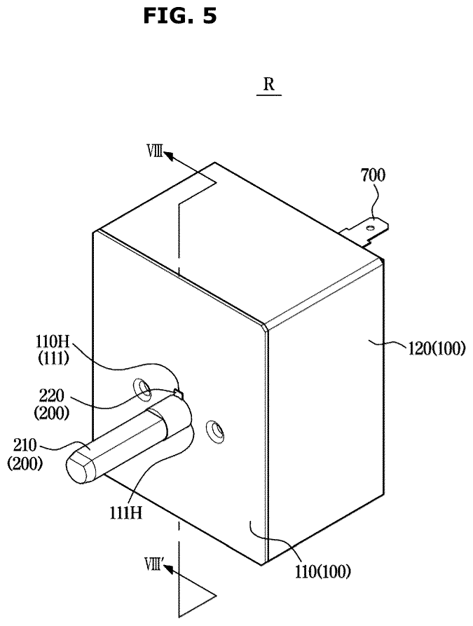

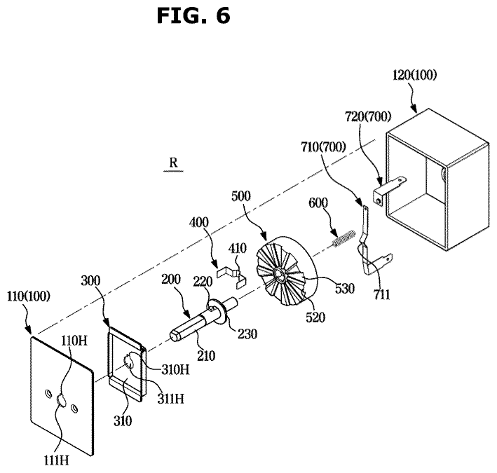

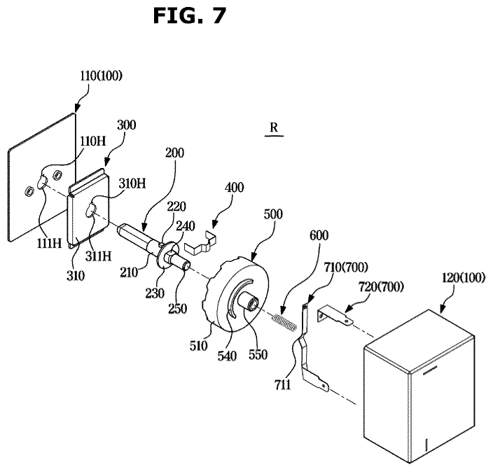

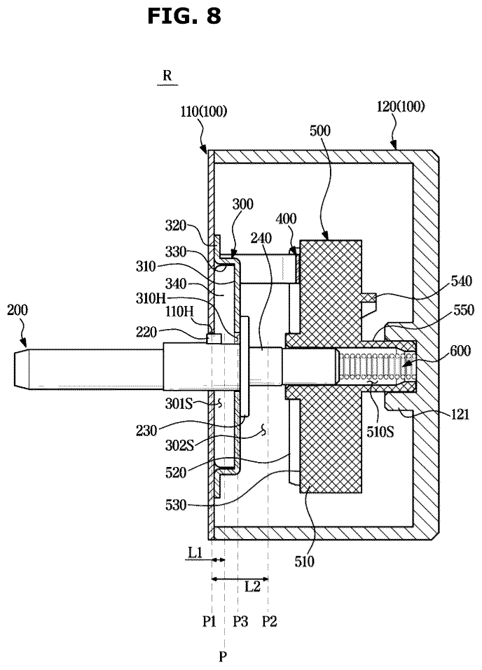

FIG. 5 is a perspective view of the regulator apparatus R shown in FIG. 4. FIG. 6 is an exploded view of the regulator apparatus R shown in FIG. 5. FIG. 7 is a rear exploded view of the regulator apparatus R shown in FIG. 5. FIG. 8 is a cross-sectional view of the regulator apparatus R shown in FIG. 5, taken along VIII-VIII′.

The regulator apparatus R according to an embodiment of the present disclosure will be described with reference to FIGS. 5 to 8.

The cooking apparatus 1 may include the regulator apparatus R.

The regulator apparatus R may include the case 100.

The case 100 may include a case body 120. The case body 120 may be a component that defines at least a portion of an appearance of the case 100.

According to the case 100 having a rectangular parallelepiped shape, the case body 120 may be a component that defines five sides of the rectangular parallelepiped.

The case body 120 may have an operation space 302S therein. The operation space 302S may be a space surrounded by the five sides of the case body 120. The operation space 302S may have an opening.

The opening of the operation space 302S may open toward the front direction.

Components which will be described below may be accommodated in the case 100 through the opening of the operation space 302S.

The case body 120 may include, but is not limited thereto, a plastic material.

The case body 120 may be formed by injection molding, although not limited thereto.

The case 100 may include a case cover 110. The case cover 110 may close the opening of the operation space 302S.

The case cover 110 may be located adjacent to the case body 120. The case cover 110 may close the operation space 302S defined by the case body 120.

According to the case 100 having a rectangular parallelepiped shape, the case cover 110 may define a remaining side other than the five sides defined by the case body 120.

The case cover 110 may be positioned in front of the case body 120.

The case cover 110 may have a flat plate shape with a preset thickness, although not limited thereto.

The case cover 110 may include, but is not limited thereto, a plastic material.

The case cover 110 may be formed by injection molding, although not limited thereto.

The case cover 110 may have a first shaft hole 111H. The shaft 200 may penetrate the first shaft hole 111H.

The first shaft hole 111H may have a shape capable of passing the shaft 200 through. According to a cross section of the shaft 200 being a circle, the first shaft hole 111H may have a cylindrical shape.

The first shaft hole 111H may have a shape corresponding to the cross section of the shaft 200. For example, the first shaft hole 111H may have a cylindrical shape having a similar diameter to that of the cross section of the shaft 200. Here, the similar diameter means that the first shaft hole 111H has a tolerance with respect to the cross section of the shaft 200 such that the shaft 200 is capable of moving through the first shaft hole 111H.

The first shaft hole 111H may be located at a center of gravity of the case cover 110. That is, according to the case cover 110 having a substantially rectangular parallelepiped shape, the first shaft hole 111H may be located at a position corresponding to a center of a diagonal.

The first shaft hole 111H may be included in the shaft (200) hole.

The case cover 110 may include a stopper groove 110H. The case 100 may include the stopper groove 110H. The stopper groove 110H may be a groove into which a stopper 220 of the shaft 200, which will be described below, is inserted.

The stopper groove 110H may be located in the case cover 110.

The stopper groove 110H may extend from the first shaft hole 111H. The stopper groove 110H may extend in a radial direction from the first shaft hole 111H.

The stopper groove 110H may have a shape corresponding to the stopper 220. The stopper 220 may be accommodated in the stopper groove 110H. After the stopper 220 is accommodated in the stopper groove 110H, the stopper 220 may be limited in moving to prevent the shaft 200 from rotating. Further descriptions thereof will be given in the following descriptions about the stopper 220.

The case cover 110 may include a first shaft hole forming portion 111. The first shaft hole forming portion 111 may be a component that defines the first shaft hole 111H or the stopper groove 110H, although not limited thereto.

However, the stopper 220 may be located on the case cover 110, and the stopper groove 110H may be located in the shaft 200. Hereinafter, for convenience of description, it is assumed that the stopper 220 is a component of the shaft 200, and the stopper groove 110H is located in the case cover 110.

The regulator apparatus R may include the shaft 200. The shaft 200 may be a component that is rotatable with respect to the case 100.

The shaft 200 may extend in a front-rear direction.

The shaft 200 may have a columnar shape having a substantially circular cross section.

The shaft 200 may penetrate the case cover 110. The shaft 200 may be movable into the case 100 along an extension direction of the shaft 200.

The shaft 200 may include a metal material. Therefore, the shaft 200 may have a rigidity to be prevented from being broken by a translational or rotational motion, although not limited thereto.

The shaft 200 may be formed by a casting process, although not limited thereto.

The shaft 200 may include a shaft body 210. The shaft body 210 may be a component that defines at least a portion of the appearance of the shaft 200.

At least a portion of the shaft body 210 may be inserted in the case 100.

The shaft 200 may include the stopper 220. The stopper 220 may be a component that prevents the shaft 200 from rotating.

The stopper 220 may protrude from the shaft body 210. The stopper 220 may be accommodated in the stopper groove 110H. While the stopper 220 is accommodated in the stopper groove 110H, the stopper 220 may be in contact with the shaft hole forming portion 111 to prevent the shaft 200 from rotating.

The stopper 220 may have a shape corresponding to the stopper groove 110H. The stopper 220 may have a shape that is similar to the stopper groove 110H. According to a cross section of the stopper 220 having a quadrangular shape, a cross section of the stopper groove 110H may also have a quadrangular shape. Although the cross section of the stopper 220 corresponds to the cross section of the stopper groove 110H, there may be a tolerance between the stopper 220 and the stopper groove 110H such that the stopper 220 passes through the stopper groove 110H.

The shaft 200 may include a shaft flange 230. The shaft flange 230 may be a component that comes into contact with an operation prevention member 300 which will be described below while the shaft 200 moves back and forth.

The shaft flange 230 may protrude in a radial direction from the shaft body 210. The shaft flange 230 may extend in a circumferential direction from the shaft body 210.

The shaft flange 230 may have a substantially disc shape.

The shaft flange 230 may be located behind the operation prevention member 300 which will be described below. The shaft flange 230 may prevent the shaft 200 from being separated in the front direction by coming into contact with the operation prevention member 300 while the shaft 200 moves in the front direction.

The shaft 200 may be prevented from being separated in a rear direction by the case 100. Accordingly, the shaft flange 230 may prevent the shaft 200 from being separated from the case 100.

The shaft flange 230 may be spaced from the stopper 220. A plate accommodating space 230S may be defined between the shaft flange 230 and the stopper 220.

In other words, the shaft flange 230 may protrude in the radial direction from the shaft body 210 to come into contact with a stopper plate 310 in order to prevent the shaft 200 from departing from the case 100 while the shaft 200 moves from a second position P2 toward a first position P1.

The stopper plate 310 may be accommodated in the plate accommodating space 230S.

In other words, the stopper 220 may be spaced from the shaft flange 230 such that the plate accommodating space 230S is provided between the stopper 220 and the shaft flange 230.

While the shaft 200 is at an operation prevention position P and the stopper 220 spins, the stopper plate 310 may be accommodated in the plate accommodation space 230S to be prevented from interfering with a rotation of the shaft 200.

This will be described with reference to the related drawing, below.

The shaft 200 may include a cylindrical portion 250. The cylindrical portion 250 may be a component that is rotatable independently from a cam 500 while being accommodated in the cam 500.

While the shaft 200 moves back and forth and only the cylindrical portion 250 is accommodated in a shaft accommodating space 510S (will be described below) of the cam 500, the shaft 200 may rotate independently from the cam 500 because the cylindrical portion 250 is rotatable independently from the cam 500. Therefore, the stopper 220 may be rotatable in an operation prevention space 301S which will be described below.

The shaft 200 may be located at the first position P1. While the shaft 200 is located at the first position P1, the stopper 220 may be accommodated in the stopper groove 110H. That is, the stopper 220 may protrude from the shaft body 210 in such a way as to be accommodated in the stopper groove 110 while the shaft 200 is located at the first position P1.

The shaft 200 may be located at the second position P2. While the shaft 200 is located at the second position P2, the stopper 220 may be spaced an operation distance L2 from the stopper groove 110H.

The shaft 200 may be located at the operation prevention position P. While the shaft 200 is located at the operation prevention position P, the stopper 220 may be spaced an operation prevention distance L1 which is shorter than the operation distance L2, from the stopper groove 110H.

While the shaft 200 is located at the second position P2, the cam 500 may rotate together with the shaft 200 to enable the regulator apparatus R to detect a user input. The cam 500 may be adjacent to the shaft 200 such that the shaft 200 is inserted into the cam 500.

While the shaft 200 is at the operation prevention position P1, the stopper 220 may be located at an inner side of the operation prevention member 300 to prevent the shaft 200 from moving from the operation prevention position P to the second position P2 in order to prevent the cam 500 from being rotated by the shaft 200. The operation prevention member 300 may be located between the cam 500 and the stopper groove 110H.

That is, while the shaft 200 is at the operation prevention position P, the stopper 220 may be located in the operation prevention space 301S. While the shaft 200 is located at the operation prevention position P, the stopper 220 may spin around a rotation axis of the shaft 200 in the operation prevention space 301S.

The cylindrical portion 250 may be located at an end of the shaft 200.

The cylindrical portion 250 will be described with reference to the related drawing, below.

The shaft 200 may include a rotation prevention portion 240. The rotation prevention portion 240 may be a component that is rotatable together with the cam 500 while being accommodated in the cam 500.

The rotation prevention portion 240 may be adjacent to the cylindrical portion 250. The rotation prevention portion 240 may be located further away from the end of the shaft 200 than the cylindrical portion 250.

When the rotation prevention portion 240 is accommodated in the shaft accommodating space 510S of the cam 500 while the shaft 200 moves back and forth, the shaft 200 may rotate together with the cam 500 because the rotation prevention portion 240 is rotatable together with the cam 500. Therefore, the regulator apparatus R may output a signal corresponding to a user input.

The rotation prevention portion 240 will be described with reference to the related drawing, below.

The regulator apparatus R may include the operation prevention member 300. The operation prevention member 300 may be a component capable of preventing the stopper 220 from rotating.

The operation prevention member 300 may have a second shaft hole 311H. The second shaft hole 311H may be a hole which the shaft 200 is capable of penetrating.

The second shaft hole 311H may be aligned with the first shaft hole 111H at a position corresponding to the first shaft hole 111H. Therefore, the shaft 200 may penetrate the first shaft hole 111H and the second shaft hole 311H.

The second shaft hole 311H may have a shape corresponding to the shaft 200.

The operation prevention member 300 may have a stopper hole 310H. The stopper hole 310H may be a groove in which the stopper 220 is accommodable.

The stopper hole 310H may pass the stopper 220 to allow the shaft 200 to move from the operation prevention position P to the second position P2.

The stopper hole 310H may extend from the second shaft hole 311H. The stopper hole 310H may extend in a radial direction from the second shaft hole 311H.

The stopper hole 310H may have a shape corresponding to the stopper 220. The stopper 220 may be accommodated in the stopper hole 310H. While the stopper 220 is accommodated in the stopper hole 310H, the stopper 220 may be limited in moving to prevent the shaft 200 from rotating.

The operation prevention member 300 may include a second shaft hole forming portion 311. The second shaft hole 311H or the stopper hole 310H may be defined by the second shaft hole forming portion 311.

While the stopper 220 is accommodated in the stopper hole 310H, the stopper 220 may be in contact with the second hole forming portion 311 and prevented from rotating. Therefore, the shaft 200 may be prevented from rotating and the regulator apparatus R may be prevented from generating a signal.

The stopper hole 310H may be located at a position corresponding to the stopper groove 110H. The stopper hole 310H may be positioned behind the stopper groove 110H. Therefore, according to a back-and-forth movement of the shaft 200, the stopper 220 may move by penetrating the stopper groove 110H and the stopper hole 310H.

In other words, the stopper hole 310H may be aligned with the stopper groove 110H in a direction that is parallel to the rotation axis of the shaft 200.

The shaft 200 may rotate after the stopper 220 moves by penetrating the stopper groove 110H and the stopper hole 310H, which will be described below. The regulator apparatus R may generate a signal corresponding to a user input while the stopper 220 rotates. Accordingly, by providing the stopper hole 310H that is different from the stopper groove 110H, the shaft 200 may be limited in rotating. The reason may be because the shaft 200 is limited in rotating until the stopper 220 penetrates the stopper hole 310H.

The operation prevention member 300 may include, but is not limited thereto, a metal material.

The operation prevention member 300 may be formed by a press process, although not limited thereto.

The operation prevention member 300 may include the stopper plate 310. The stopper plate 310 may be a component that defines the operation prevention space 310S together with the case cover 110.

The stopper plate 310 may be spaced from the case cover 110. The operation prevention space 301S may be defined between the stopper plate 310 and the case cover 110.

While the stopper 220 is located in the operation prevention space 301S, the stopper 220 may be rotatable. While the stopper 220 rotates, the stopper 220 may be located at a position that does not correspond to the stopper hole 310H. Therefore, the stopper 220 may be limited in moving back and forth by coming into contact with the stopper plate 310. A user may need to rotate the shaft 200 to locate the stopper 220 at a position corresponding to the stopper groove 110H or the stopper hole 310 in order to enable a back-and-forth movement of the shaft 200.

When the shaft 200 moves back and forth and the stopper 220 penetrates the stopper hole 310H, the regulator apparatus R may generate a signal corresponding to a user input.

The stopper 220 may orbit the rotation axis of the shaft 200 in the operation prevention space 301S, which will be described below.

The stopper plate 310 may have a flat plate shape. Therefore, while the stopper 220 performs an orbital motion, the stopper plate 310 may be prevented from interfering with the motion of the stopper 220.

While the shaft 200 located at the operation prevention position P rotates about the rotation axis, the stopper 220 may be misaligned with the position corresponding to the stopper hole 310H and accordingly, the stopper plate 310 may come into contact with the stopper 220 to prevent the shaft 200 from moving to the second position P2.

The operation prevention member 300 may include a plate support 320. The plate support 320 may be a component that is in contact with the case cover 110.

The plate support 320 may be in contact with the case cover 110. Therefore, the plate support 320 may support the stopper plate 310.

The plate support 320 may extend in a vertical direction. The plate support 320 may extend in a direction that is parallel to an extension direction of the case cover 110. Therefore, a contact area of the plate support 320 with the case cover 110 may be widened. By widening the area of the plate support 320 that applies pressure to the case cover 110, the case cover 110 may be prevented from being deformed.

The operation prevention member 300 may include a plate connecting portion 320. The plate connecting portion 330 may be a component that connects the stopper plate 310 to the plate support 320.

The plate connecting portion 330 may connect the stopper plate 310 to the plate support 320. The plate connecting portion 330 may be positioned between the stopper plate 310 and the plate support 320.

The plate connection portion 330 may extend in the front-rear direction.

The regulator apparatus R may include the cam 500. The cam 500 may be a component that receives a rotational force from the shaft 200.

The cam 500 may rotate together with the shaft 200.

The cam 500 may rotate with respect to the case body 120. Therefore, the cam 500 may rotate while being supported on the case body 120.

The cam 500 may have a shaft accommodating space 510S in which the shaft 200 is accommodated.

The shaft accommodating space 510S may be located to correspond to the rotation axis of the shaft 200. The shaft accommodating space 510S may extend in a direction in which the rotation axis of the shaft 200 extends.

The shaft accommodating space 510S may be formed by penetrating the cam 500, although not limited thereto. However, the shaft accommodating space 510S may be formed as a groove by covering an end of the cam 500.

The shaft 200 may be accommodated in the shaft accommodating space 510S. At least a portion of the shaft 200 may be accommodated in the shaft accommodating space 510S. Therefore, the shaft accommodating space 510S may guide a back-and-forth movement of the shaft 200.

The cam 500 may rotate together with the shaft 200 or be prevented from rotating even though the shaft 200 rotates, depending on a degree by which the shaft 200 is accommodated into the shaft accommodating space 510S. This will be described with reference to the related drawing, below.

The cam 500 may include, but is not limited thereto, a plastic material.

The cam 500 may be formed by an injection molding process, although not limited thereto.

The cam 500 may include a convex portion 520 and a concave portion 530. The convex portion 520 and the concave portion 530 may be components that are capable of contacting a ticker 400 which will be described below.

The convex portion 520 may protrude toward the operation prevention member 300.

The concave portion 530 may be located adjacent to the convex portion 520.

The concave portion 530 may be concave in a direction that is away from the operation prevention member 300.

A plurality of convex portions 520 may be provided.

A plurality of concave portions 530 may be provided.

The plurality of convex portions 520 may be arranged in a circumferential direction around a rotation axis of the cam 500 alternately with the plurality of concave portions 530. Therefore, the ticker 400 which will be described below may cause a user to feel a sense of operation while moving on surfaces of the convex portions 520 and the concave portions 530.

The cam 500 may include a pressing rib 540. The pressing rib 540 may be a component capable of pressing a terminal 700 which will be described below.

While the cam 500 rotates, the pressing rib 540 may press or not press the terminal 700.

The pressing rib 540 will be described with reference to the related drawing, below.

The regulator apparatus R may include the ticker 400. The ticker 400 may be a component that causes a user to feel a sense of operation.

The ticker 400 may be coupled to the operation prevention member 300.

The ticker 400 may be located between the operation prevention member 300 and the cam 500.

The ticker 400 may be elastically deformable.

The ticker 400 may form a space at the center and at least partially surround the space.

The ticker 400 may include a shape protruding toward the cam 500. The protruding shape of the ticker 400 may be a shape capable of being accommodated in the concave portion 530 of the cam 500.

The ticker 400 may contact the convex portion 520 and the concave portion 530 of the cam 500. Accordingly, while the cam 500 rotates, the ticker 400 may be deformed in shape to contact the convex portion 520 and the concave portion 530. The ticker 400 may be fixed in position and contact the convex portion 520 and the concave portion 530 according to a movement of the cam 500. By vibration and sound generated according to the ticker 400 contacting the convex portion 520 and the concave portion 530, a user may recognize a rotation of the cam 500.

The ticker 400 may include, but is not limited thereto, a metal material.

The ticker 400 may be formed by a press process, although not limited thereto.

The regulator apparatus R may include the terminal 700. The terminal 700 may be a component through which electricity flows.

The terminal 700 may include a first terminal 710 and a second terminal 720.

The first terminal 710 may be coupled to the case body 120. The first terminal 710 may be coupled to a rear wall of the case body 120.

At least a portion of the first terminal 710 may be positioned inside the case body 120.

The first terminal 710 may have a shape extending in one direction. A

portion adjacent to an end of the first terminal 710 may be coupled to the case body 120, and another end may be a free end 712.

The second terminal 720 may be coupled to the case body 120.

At least a portion of the second terminal 720 may be located inside the case body 120.

The second terminal 720 may be located to correspond to the free end 712 of the first terminal 710. While the free end 712 of the first terminal 710 is in contact with the second terminal 720, the second terminal 720 may be electrically connected to the first terminal 710. While the first terminal 710 contacts the second terminal 720, the regulator apparatus R may generate a signal corresponding to a user input. The free end 712 of the first terminal 710 may come closer to the second terminal 720 according to an orbital motion of the pressing rib 540 of the cam 500.

This will be described with reference to the related drawing, below.

The regulator apparatus R may include an elastic member 600. The elastic member 600 may be a component that presses the shaft 200 in the front direction.

The elastic member 600 may be accommodated in the shaft accommodating space 510S of the cam 500. The elastic member 600 may be located between the shaft 200 and the cam 500.

The elastic member 600 may be a component that presses the shaft 200 to locate the stopper 220 at the stopper groove 110H. The elastic member 600 may press the cylindrical portion 250. The elastic member 600 may come into contact with the cylindrical portion 250. The elastic member 600 compressed by the shaft 200 may press the shaft 200 in an opposite direction of a direction in which the elastic member 600 has been compressed.

A user may generate a signal in the regulator apparatus R by pressing the shaft 200 and then rotating the shaft 200. In the case in which the user wants to stop generating a signal in the regulator apparatus R, the user may return the shaft 200 to an original position by releasing pressure applied to the shaft 200.

For example, the elastic member 600 may include a compression spring.

More details are provided below along with related drawings.

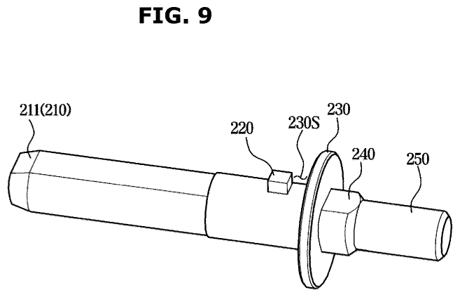

FIG. 9 is a perspective view of the shaft 200 shown in FIG. 8.

The shaft 200 according to an embodiment of the present disclosure will be described with reference to FIG. 9.

The shaft 200 may include the shaft body 210.

The shaft body 210 may include the knob installing portion 211 at one end. The knob installing portion 211 may be coupled to the knob N1 (see FIG. 4). A D-cut may be provided in the knob installing portion 211. The knob N1 may also be provided with the shaft (200) installing hole (see FIG. 4) having a shape corresponding to the D-cut. After the knob installing portion 211 is accommodated in the shaft (200) installing hole, the knob installing portion 211 may rotate according to a rotation of the knob N1.

The shaft 200 may include the shaft flange 230. The shaft flange 230 may be located at another end of the shaft body 210.

The shaft 200 may include the stopper 220. The stopper 220 may be located between the shaft flange 230 and the knob installing portion 211. The stopper 220 may protrude with a smaller length in a radial direction than the shaft flange 230 protruding in the radial direction.

The shaft 200 may include the cylindrical portion 250 at one end. The cylindrical portion 250 may have a cylindrical shape. Because the cylindrical portion 250 is rotationally symmetrical to the axis, the cylindrical portion 250 may be rotatable independently from the cam 500.

In other words, the cylindrical portion 250 may be at one end of the shaft 200 toward the cam 500. According to the shaft 200 being at the operation prevention position P, the cylindrical portion 250 may be accommodated in the cam 500 in such a way as to be rotatable independently from the cam 500.

The shaft 200 may include the rotation prevention portion 240. The rotation prevention portion 240 may have a shape that is rotationally asymmetrical to the rotation axis of the shaft 200. Therefore, while the rotation prevention portion 240 is in contact with the cam 500, the rotation prevention portion 240 may rotate together with the cam 500.

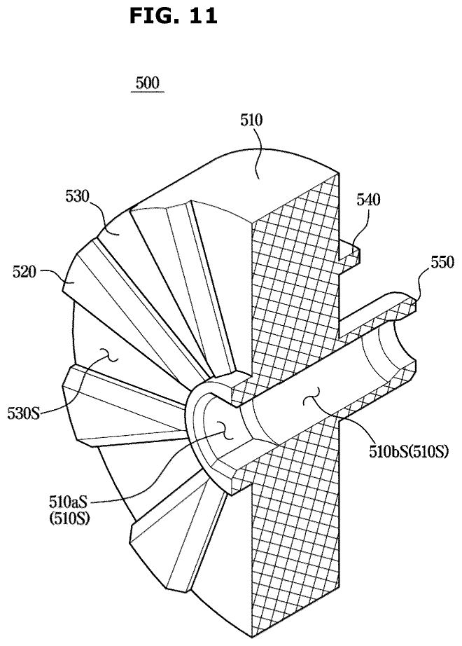

The rotation prevention portion 240 may be adjacent to the cylindrical portion 250. The rotation prevention portion 240 may be located in front of the cylindrical portion 250. Therefore, while the shaft 200 moves toward the cam 500 (see FIG. 11), the cylindrical portion 250 may be first inserted into the shaft accommodating space 510S defined in the cam 500 and then the rotation prevention portion 240 may be inserted in the shaft accommodating space 510S. Accordingly, the shaft 200 moving toward the cam 500 may be rotatable independently from the cam 500 and when the shaft 200 further moves toward the cam 500, the shaft 200 may be rotatable together with the cam 500.

The rotation prevention portion 240 may have a shape that is rotationally asymmetrical to the rotation axis. The rotation prevention portion 240 may not have a cylindrical shape. For example, the rotation prevention portion 240 may have a shape cut along a plane including an extension direction of the cylinder. In this case, a radius of the rotation prevention portion 240 may be larger than that of the cylindrical portion 250. That is, a step may be made between a cylindrical portion accommodating space 510bS (see FIG. 11) and a rotation prevention portion accommodating space 510aS (see FIG. 11), which will be described below. Therefore, a user may recognize the shaft 500 located close to the cam 500 enough to rotate the cam 500.

According to the shaft 200 being at the second position P2, the rotation prevention portion 240 may be accommodated in the cam 500 to be rotatable together with the cam 500.

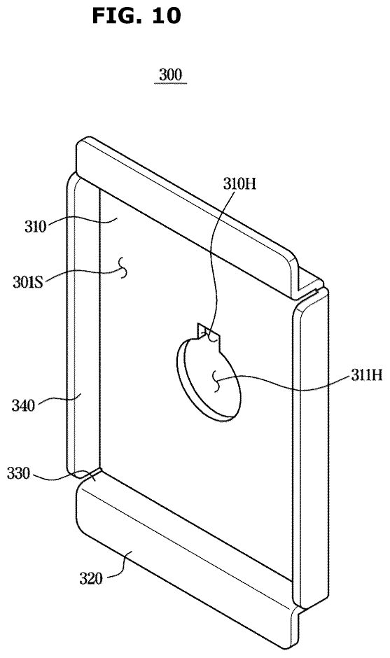

FIG. 10 is a perspective view of the operation prevention member 300 shown in FIG. 8.

The operation prevention member 300 according to an embodiment of the present disclosure will be described with reference to FIG. 10.

The cooking apparatus 1 may include the regulator apparatus R.

The regulator apparatus R may include the operation prevention member 300.

The operation prevention member 300 may include the stopper plate 310.

The stopper plate 310 may have a quadrangular flat plate shape.

The stopper plate 310 may include a second shaft (200) accommodating groove.

The stopper plate 310 may have a second stopper (220) accommodating groove. The second stopper (220) accommodating groove may extend from the second shaft (200) accommodating hole.

The operation prevention member 300 may include the plate connecting portion 330.

A plurality of plate connecting portions 330 may be provided. The plurality of plate connecting portions 330 may be respectively bent from two opposite sides of the stopper plate 310 and extend. The plurality of plate connecting portions 330 may extend toward the front direction.

The operation prevention member 300 may include the plate support 320.

A plurality of plate supports 320 may be provided. Each of the plurality of plate supports 320 may be bent from an end of each of the plurality of plate connecting portions 330 and extend. Therefore, the stopper plate 310 may be stably supported.

The operation prevention member 300 may include a plate support connecting portion 340.

A plurality of plate support connecting portions 340 may be provided. The plurality of plate support connecting portions 340 may be respectively bent from the remaining two sides of the stopper plate 310 not connected to the plurality of plate connecting portions 330, and extend.

The plurality of plate support connecting portion 340 may extend along a direction that is parallel to a direction in which the plurality of plate connecting portions 330 extend. Therefore, the plurality of plate support connecting portions 340 and the plurality of plate connecting portions 330 may surround the operation prevention space 301S.

The operation prevention space 301S may be defined by the stopper plate 310, the plate support connecting portions 340, and the plate connecting portions 330.

The plurality of plate support connecting portions 340 may extend up to a plane to which ends of the plurality of plate supports 320 belong. Therefore, the plurality of plate support connecting portions 340 may stably support the operation prevention member 300 together with the plurality of plate supports 320.

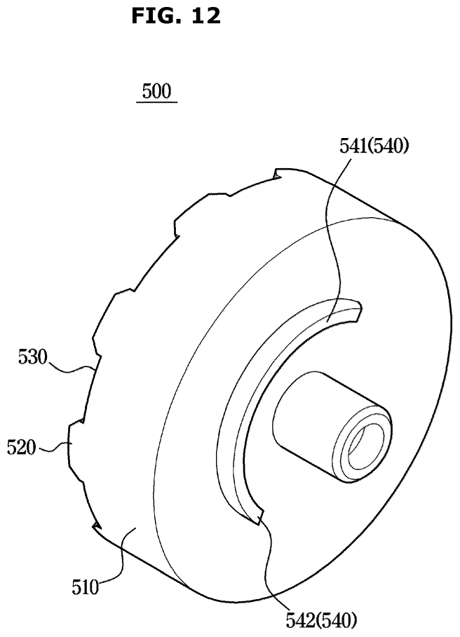

FIG. 11 is a cross-sectional perspective view of the cam 500 shown in FIG. 8. FIG. 12 is a rear perspective view showing a rear side of the cam 500 shown in FIG. 11.

The cam 500 according to an embodiment of the present disclosure will be described with reference to FIGS. 11 and 12.

The cooking apparatus 1 may include the regulator apparatus R.

The regulator apparatus R may include the cam 500.

The cam 500 may include the cam body 510. The cam body 510 may be a component that defines at least a portion of an appearance of the cam 500.

The cam body 510 may have a substantially cylindrical shape.

The cam 500 may have the shaft accommodating space 510S. The shaft accommodating space 510S may be a space in which the shaft 200 is accommodated.

The shaft accommodating space 510S may extend along the rotation axis of the cam 500.

The shaft accommodating space 510S may include an opening located in the front area. The shaft 200 may be inserted into the cam 500 through the opening of the shaft accommodating space 510S.

The shaft accommodating space 510S may have an opening located in the rear area. Therefore, the shaft accommodating space 510S may be easily formed in the cam 500. The reason may be because the shaft accommodating space 510S is formed through a process of punching a hole in the cam 500. However, the present disclosure is not limited thereto, and the shaft accommodating space 510S may have no opening in the rear area. In this case, the shaft accommodating space 510S may be a space that defines an opening only in the front area.

The shaft accommodating space 510S may include the cylindrical portion accommodating space 510bS. The cylindrical portion accommodating space 510bS may be a space in which the cylindrical portion 250 (see FIG. 10) of the shaft 200 is accommodated.

Because the cylindrical portion 250 has a cylindrical shape, the cylindrical portion accommodating space 510bS may also have a cylindrical shape to correspond to the cylindrical portion 250. A cylinder rotation center axis of the cylindrical portion 250 may be identical to a cylinder rotation center axis of the cylindrical portion accommodating space 510bS. Therefore, while the cylindrical portion 250 is inserted in the cylindrical portion accommodating space 510bS and rotates about the cylinder rotation center axis, the cylindrical portion 250 may rotate freely. This may be contrasted with the rotation prevention portion 240 that is inserted into the rotation prevention portion accommodating space 510aS and does not freely rotate with respect to the cam 500, which will be described below.

The cylindrical portion accommodating space 510bS may be defined by the cam body 510. The cylindrical portion accommodating space 510bS may be defined by a cam protrusion 550. The cylindrical portion accommodating space 510bS may be defined by the cam body 510 and the cam protrusion 550.

The cylindrical portion accommodating space 510bS may extend in the front-rear direction to limit interference with the shaft 200 moving in the front-rear direction.

The cylindrical portion accommodating space 510bS may be located in a rear portion of the cam 500.

The cylindrical portion accommodating space 510bS may include the rotation prevention portion accommodating space 510aS. The rotation prevention portion accommodating space 510aS may be a space capable of accommodating the rotation prevention portion 240 (see FIG. 10).

The rotation prevention portion 240 may have a shape that is rotationally asymmetrical to the rotation axis, as described above. For example, the rotation prevention portion 240 may have a shape obtained by cutting a cylindrical shape. That is, the rotation prevention portion 240 may have a D-cut.

The rotation prevention portion accommodating space 510aS may have a shape corresponding to the rotation prevention portion 240. While the rotation prevention portion 240 accommodated in the rotation prevention portion accommodating space 510aS rotates, the rotation prevention portion 240 may press the cam 500. While the rotation prevention portion 240 rotates, the cam 500 may rotate together with the rotation prevention portion 240. That is, while the rotation prevention portion 240 is located in the rotation prevention portion accommodating space 510aS, the cam 500 may rotate according to a rotation of the shaft 200. While the rotation prevention portion 240 is not located in the rotation prevention portion accommodating space 510aS, the cam 500 may be prevented from rotating even through the shaft 200 rotates.

The rotation prevention portion accommodating space 510aS may be defined by the cam body 510.

A diameter of the rotation prevention portion accommodating space 510aS may be larger than a diameter of the cylindrical portion accommodating space 510bS. A step may be located between the rotation prevention portion accommodating space 510aS and the cylindrical portion accommodating space 510bS. While the rotation prevention portion 240 of the shaft 200 is in contact with the step, the shaft 200 may be prevented from moving in the rear direction. Therefore, a user may recognize that the shaft 200 moves together with the cam 500.

The cam 500 may include the convex portion 520 and the concave portion 530. The convex portion 520 may have a shape that protrudes in the front direction more than the concave portion 530.

The concave portion 530 may have a shape that is concave in the rear direction more than the convex portion 520. Therefore, a fixer accommodating space may be provided in front of the concave portion 530. A fixer (see FIG. 8) may be accommodated in the fixer accommodating space.

The plurality of convex portions 520 may be provided. The plurality of concave portions 530 may be provided. The plurality of convex portions 520 may be arranged in a circumferential direction around the rotation axis of the cam 500 alternately with the plurality of concave portions 530.

Each convex portion 520 may substantially have a fan shape. Each concave portion 530 may substantially have a fan shape.

The cam 500 may include the cam protrusion 550. The cam protrusion 550 may be a component that extends to the case 100 and is supported on the case 100 (see FIG. 8).

The cam protrusion 550 may be located on a rear side of the cam body 510.

The cam protrusion 550 may protrude from the cam body 510 toward the rear direction.

The cam protrusion 550 may extend along the rotation axis of the cam 500.

The cam protrusion 550 may have a columnar shape with a donut-shaped cross section.

The cam 500 may include the pressing rib 540. The pressing rib 540 may be a component that presses the terminal 700 (see FIG. 7).

The pressing rib 540 may be located on the rear side of the cam body 510.

The pressing rib 540 may protrude from the cam body 510 toward the rear direction.

The pressing rib 540 may extend in a circumferential direction around the rotation axis of the cam 500.

The pressing rib 540 may partially extend in the circumferential direction around the rotation axis of the cam 500. Accordingly, the pressing rib 540 may have a shape corresponding to a part of a circle. Accordingly, only while the pressing rib 540 comes into contact with the terminal 700, the terminal 700 may be pressed. Because the terminal 700 moves only by being pressed by the pressing rib 540 according to a rotation of the cam 500, the terminal 700 may generate another signal according to a rotation of the cam 500. This will be described with reference to the related drawing, below.

The pressing rib 540 may be spaced from the cam protrusion 550.

So far, a configuration of the regulator apparatus R according to an embodiment of the present disclosure has been described. Hereinafter, an operation of the regulator apparatus R according to an embodiment of the present disclosure will be described with reference to the related drawing.

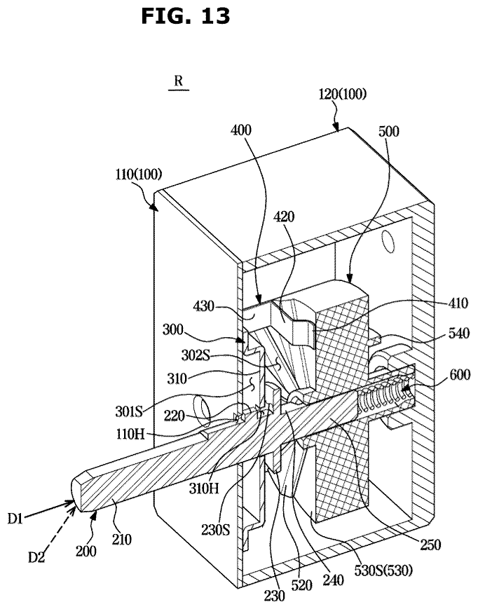

FIG. 13 is a cross-sectional perspective view of the regulator apparatus R shown in FIG. 8 while the shaft 200 of the regulator apparatus R is pressed from the first position P1 to the second position P2.

A movement of the shaft 200 of the regulator apparatus R according to an embodiment of the present disclosure will be described with reference to FIG. 13.

The cooking apparatus 1 may include the regulator apparatus R. The regulator apparatus R may include the shaft 200. The shaft 200 may include the stopper 220.

The shaft 200 may be located at the first position P1 at which the stopper 220 is accommodated in the stopper groove 110H. When a user attempts to rotate the shaft 200 located at the first position P1, the shaft 200 will not rotate because the stopper 220 comes into contact with the case cover 110. The shaft 200 may rotate to rotate the cam 500, and the cam 500 may rotate to generate a signal corresponding to a user input in the terminal 700. Accordingly, while the stopper 220 is located in the stopper groove 110H, an operation of the cooking apparatus 1, not intended by a user, may be limited.

While the shaft 200 is pressed toward the rear direction, the stopper 220 may be located in the operation space 302S located behind the operation prevention member 300. The shaft 200 may be located at the second position P2 at which the stopper 220 is located in the operation space 302S.

While the shaft 200 is located at the second position P2, the shaft 200 may rotate together with the cam 500. Therefore, the regulator apparatus R may output a signal corresponding to a user input.

The shaft 200 may move back and forth between the first position P1 and the second position P2. The shaft 200 may move from the first position P1 to the second position P2 by moving in the front-rear direction. While the shaft 200 moves from the first position P1 to the second position 2, the shaft 200 may move along the rotation axis.

To move the shaft 200 from the first position P1 to the second position P2, the shaft 200 may need to be pressed in a direction that is parallel to the extension direction of the rotation axis, which will be described below. This direction is referred to as a normal direction D1, and a direction having a preset angle with respect to the normal direction D1 is referred to as an abnormal direction D2. While the shaft 200 is pressed in the abnormal direction D2, the operation prevention member 300 may prevent the shaft 200 from moving from the first position P1 to the second position P2. Details about this will be described with reference to the related drawing, below.

The shaft 200 may be located at a third position P3 at which the stopper 220 is accommodated in the stopper hole 310H. The shaft 200 may move to the third position P3 between the first position P1 and the second position P2.

While the shaft 200 is located at the third position P3, the shaft 200 may be prevented from rotating due to the stopper hole 310H.

The shaft 200 may move to the operation prevention position P at which the stopper 220 is located in the operation prevention space 301S. The shaft 200 may move to the operation prevention position P between the first position P1 and the third position P3.

As such, the shaft 200 may be pressed in the normal direction D1 or the abnormal direction D2.

The normal direction D1 in which the shaft 200 is pressed may be a direction in which the shaft 200 is pressed according to a user's intention. In this case, the shaft 200 may be prevented from rotating by a user and pressed toward the cam 500.

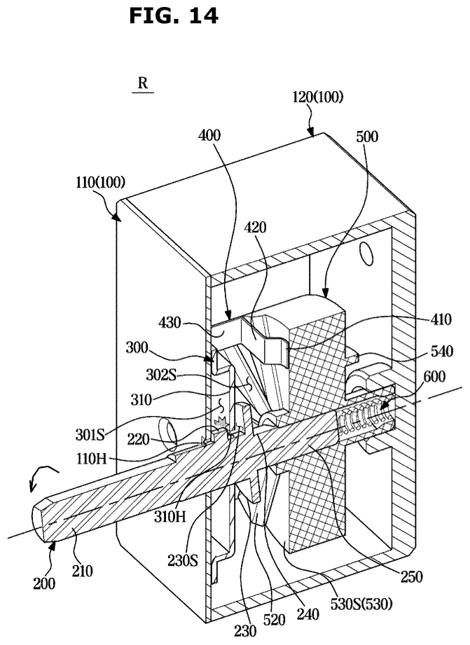

The abnormal direction D2 in which the shaft 200 is pressed may be a direction in which the shaft 200 is pressed while rotating due to a user leaned on the knob N1 or the like. In FIG. 14, a case where the shaft 200 is pressed at a preset angle with respect to the rotation axis of the shaft 200 is shown as pressurization in the abnormal direction D2, but without being limited thereto, the shaft 200 is pressed in the abnormal direction D2 may also include a case where the shaft 200 rotates while being pressed.

A positional relationship of the shaft 200 while the shaft 200 is pressed in the abnormal direction D2 will be described below.

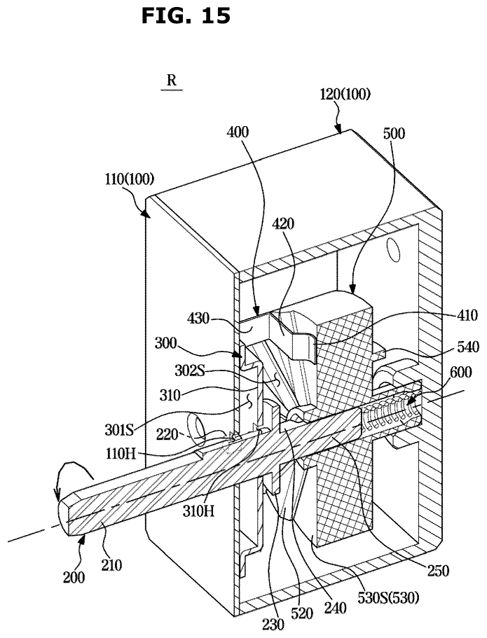

FIG. 14 is a cross-sectional perspective view of the regulator apparatus R shown in FIG. 13 while the shaft 200 of the regulator apparatus R is pressed in the abnormal direction D2. FIG. 15 is a cross-sectional perspective view of the regulator apparatus R shown in FIG. 14 while the shaft 200 of the regulator apparatus R rotates in the operation prevention space 301S.

A case in which the regulator apparatus R according to an embodiment of the present disclosure moves due to a user's carelessness will be described with reference to FIGS. 14 to 15.

The cooking apparatus 1 may include the regulator apparatus R. The regulator apparatus R may include the shaft 200.

According to the shaft 200 being pressed in the abnormal direction D2, the stopper 220 may depart from the stopper groove 110H and fail to penetrate the stopper hole 310H. While the shaft 200 moves from the first position P1 to the third position P3, the stopper 220 may fail to penetrate the stopper hole 310H.

The stopper groove 110H and the stopper hole 310H may be aligned along a direction that is parallel to the extension direction of the shaft 200. Accordingly, while the stopper 220 moves along a straight path from the stopper groove 110H to the stopper hole 310H, the stopper 220 may depart from the stopper groove 110H and penetrate the stopper hole 310H. However, when the stopper 220 rotates while departing from the stopper groove 110H and moves close to the stopper hole 310H aligned with the stopper groove 110H, the stopper 220 may come into contact with the stopper plate 310 adjacent to the stopper hole 310H without penetrating the stopper hole 310H. The stopper 220 may be blocked by the stopper plate 310 to be prevented from moving to the operation space 302S. That is, the stopper 220 may be located in the operation prevention space 301S.

While the stopper 220 is located in the operation prevention space 301S, at least a part of the cylindrical portion 250 of the shaft 200 may be accommodated in the cylindrical portion accommodating space 510bS of the cam 500. Also, the rotation prevention portion 240 of the shaft 200 may not be accommodated in the rotation prevention portion accommodating space 510aS of the cam 500. The reason may be because the cylindrical portion 250 is located behind the rotation prevention portion 240. Additionally, the reason may be because the cylindrical portion accommodating space 510bS is located behind the rotation prevention portion accommodating space 510aS.

While the shaft 200 moves in the rear direction, the cylindrical portion 250 being a rear part of the shaft 200 may be accommodated in the cylindrical portion accommodating space 510bS. In this case, even though the rotation prevention portion accommodating space 510aS is located in the front direction more than the cylindrical portion accommodating space 510bS, the rotation prevention portion 240 may be prevented from moving in the front direction to be accommodated in the rotation prevention portion accommodating space 510aS. The reason may be because the stopper 220 comes into contact with the stopper plate 310 and is prevented from moving in the front direction of the shaft 200.

Because the cylindrical portion 250 is located in the cylindrical portion accommodating space 510bS and the rotation prevention portion 240 is not located in the rotation prevention portion accommodating space 510aS, the shaft 200 may rotate independently without rotating the cam 500. Therefore, the regulator apparatus R may not generate a signal corresponding to a user input even though the shaft 200 rotates.

The stopper 220 may spin. When the shaft 200 is seen from the front, the stopper 220 may spin around the rotation axis of the shaft 200. In other words, the stopper 220 may revolve around a center of rotation of the shaft 200. Also, the stopper 220 may perform an orbital motion around the center of rotation of the shaft 200.

A position at which the stopper 220 is accommodated in the stopper groove 110H is referred to as a first spin position of the stopper 220. The stopper 220 may spin in a clockwise or counterclockwise direction around the rotation axis of the shaft 200 starting from the first spin position.

While the shaft 200 rotates by receiving a force in the abnormal direction D2, the stopper 220 may move to a second spin position moved in a circumferential direction from the first spin position. The stopper 220 located at the second spin position may come into contact with the stopper plate 310.

While the stopper 220 is located at the second spin position, the stopper 220 may fail to penetrate the stopper hole 310H even though the shaft 200 attempts to move from the first position P1 to the second position P2.

Accordingly, in the case in which the shaft 200 is at the first position P1 and the stopper 220 is at the first spin position, the stopper 220 may depart from the stopper groove 110H while the shaft 200 moves to the operation prevention position P.

While the shaft 200 is at the operation prevention position P, the stopper 220 may spin around the rotation axis of the shaft 200 in the operation prevention space 301S.

While the shaft 200 is at the operation prevention position P, the cam 500 may be prevented from rotating together with the shaft 200 to prevent the regulator apparatus R from detecting a user input.

When an attempt to move the shaft 200 from the operation prevention position P to the third position P3 is made and then the shaft 200 rotates to move the stopper 220 from the first spin position to the second spin position, the stopper 220 may fail to penetrate the stopper hole 310H. In this case, the stopper 220 may come into contact with the operation prevention member 300. More specifically, the stopper 220 may come into contact with the stopper plate 310.

While the stopper 220 is located in the operation prevention space 301S, the shaft 200 may rotate to move from the first position P1 or the second position P2.

While the shaft 200 rotates, the stopper 220 may move from the second spin position to the first spin position. In this case, the shaft 200 may rotate in the clockwise or counterclockwise direction to move the stopper 220 to the first spin position.

The shaft 200 may rotate by a user who grips the knob N1 and rotates the knob N1. This action will be done according to the user's intention. Accordingly, while the stopper 220 is at the operation prevention space 301S, the user will intentionally operate the knob N1 to change a position of the stopper 220 or the shaft 200. Particularly, the stopper 220 may need to move from the second spin position to the first spin position to move the shaft 200 from the operation prevention position P to the first position P1. Because moving the stopper 220 to the first spin position requires a user's attention, a movement of the stopper 220 to the first spin position will be done according to the user's intended operation.

While the stopper 220 moves from the second spin position to the first rotation prevention portion 240 in the operation prevention space 301S, the stopper 220 may move while being in contact with the case cover 110. The reason may be because the elastic member 600 presses the shaft 200 in a direction from the operation prevention position P toward the first position P1.

While the shaft 200 is at the first position P1, the elastic member 600 may be pressed between the shaft 200 and the cam 500 or between the shaft 200 and the case body 120. The elastic member 600 may press the shaft 200 in the front direction.

While the stopper 220 moves from the second spin position to the first spin position, the elastic member 600 may press the shaft 200 in the front direction. The shaft 200 may move in the front direction by the elastic member 600.

The elastic member 600 may be accommodated in the cam 500 to press the shaft 200 in a direction from the second position P2 toward the first position P1.

In this case, the shaft flange 230 may come into contact with the operation prevention member 300 to prevent the shaft 200 from moving in the front direction. While the shaft flange 230 is in contact with the stopper plate 310, the shaft 200 may be at the first position P1. The shaft flange 230 may guide the shaft 200 to be located at the first position P1 while the shaft 200 moves in the front direction.

When the stopper 220 spins while the shaft 200 is at the operation prevention position P, the stopper plate 310 may be located in the plate accommodating space 230S located between the stopper 220 and the stopper flange 230. The plate accommodating space 230S may accommodate the stopper plate 310 while the stopper 220 spins. The stopper flange 230 may be spaced from the stopper 220 such that the stopper plate 310 is accommodated in the plate accommodating space 230S.

A width of the plate accommodating space 230S may be similar to a width of the stopper plate 310. A width that is similar to the width of the plate accommodating space 230S may be a width corresponding to the width of the stopper plate 310 and having a tolerance by which the stopper plate 310 is movable within the plate accommodating space 230S.

So far, a case in which the shaft 200 is located in the operation prevention space 301S and the shaft 200 fails to move to the second position P2 has been described. Hereinafter, a case in which the shaft 200 is located in the operation space 302S and the regulator apparatus R generates a signal will be described.

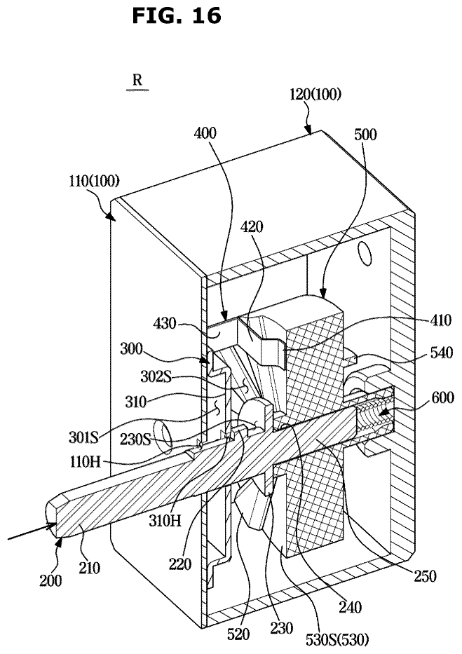

FIG. 16 is a cross-sectional perspective view of the regulator apparatus R shown in FIG. 13 while the shaft 200 of the regulator apparatus R is pressed from the second position P2 to the third position P3.

A case in which the shaft 200 according to an embodiment of the present disclosure rotates together with the cam 500 will be described with reference to FIG. 16.

While the shaft 200 is pressed in the normal direction D1, the shaft 200 may move from the first position P to the second position P2. While the shaft 200 is pressed in the normal direction D1, the stopper 220 may be limited from moving from the first spin position to the second spin position. While the shaft 200 is pressed in the normal direction D1, the stopper 220 may depart from the stopper groove 110H, pass through the operation prevention space 301S, penetrate the stopper hole 310H, and be located in the operation space 302S.

While the shaft 200 is located at the second position P2, the stopper 220 may be located in the operation space 302S.

While the shaft 200 is at the second position P2, the cylindrical portion 250 may move further in the rear direction. The cylindrical portion 250 may be accommodated in the cylindrical portion accommodating space 510bS of the cam 500.

While the shaft 200 is at the second position P2, the rotation prevention portion 240 may be accommodated in the rotation prevention portion accommodating space 510aS of the cam 500. The rotation prevention portion 240 located in the rotation prevention portion accommodating space 510aS may rotate while pressing the cam 500 while the shaft 200 rotates. Therefore, the shaft 200 and the cam 500 may rotate together.

A user may push the knob N1 to move the shaft 200 from the first position P1 to the second position P2. In this case, while the user turns the knob N1 to rotate the shaft 200, the cam 500 may rotate together with the shaft 200.

While the shaft 200 rotates at the second position P2, the stopper 220 may move from the first spin position to the second spin position. While the stopper 220 is at the second spin position, the stopper 220 may fail to penetrate the stopper hole 310H, as described above.

While the stopper 220 is at the second spin position, the stopper 220 may be in contact with the stopper plate 310 to be prevented from moving to the first position P1. That is, the stopper plate 310 may locate the stopper 220 in the operation prevention space 301S without interfering with a rotation of the stopper 220, and at this time, the rotation prevention portion 240 of the shaft 200 may not be accommodated in the rotation prevention portion accommodating space 510aS of the cam 500.

Furthermore, while the shaft 200 is at the second position P2, the stopper plate 310 may be positioned such that the stopper 220 is in contact with the stopper plate 310 and the rotation prevention portion 240 of the shaft 200 does not depart from the rotation prevention portion accommodating space 510aS of the cam 500. Because the elastic member 600 presses the shaft 200 in the front direction, when the stopper 220 is not in contact with the stopper plate 310 at the second position P2 of the shaft 200, the shaft 200 may move in the front direction and the rotation prevention portion 240 of the shaft 200 may depart from the rotation prevention portion accommodating space 510aS of the cam 500. In this case, the cam 500 may not rotate according to a rotation of the shaft 200. In order to prevent this, while the shaft 200 is at the second position P2 and the stopper 220 is at the second spin position, the stopper 220 may be in contact with the stopper plate 310 to prevent the shaft 200 from moving to the first position P1.

Hereinafter, a configuration of providing a sense of operation while the shaft 200 rotates will be described.

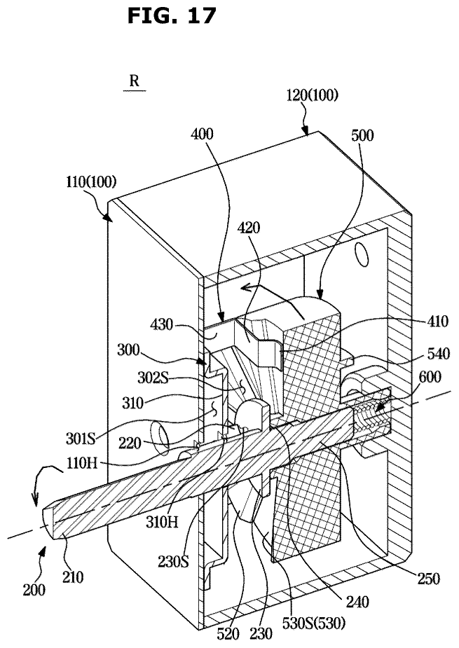

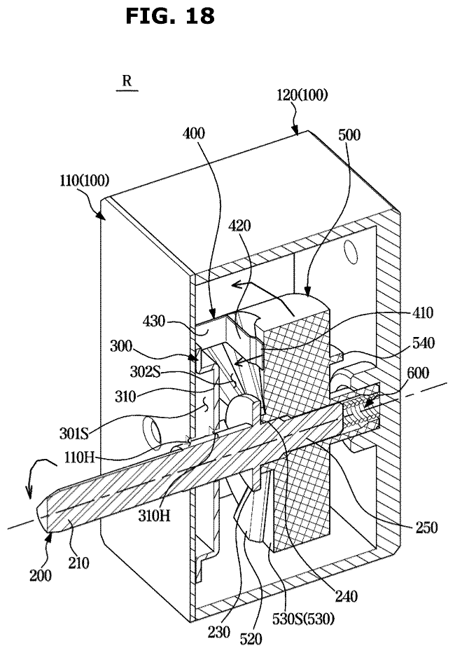

FIG. 17 is a cross-sectional perspective view of the regulator apparatus R shown in FIG. 16 while the shaft 200 of the regulator apparatus R rotates. FIG. 18 is a cross-sectional perspective view of the regulator apparatus shown in FIG. 17 when the ticker 400 comes into contact with the concave portion 530 or the convex portion 520 of the cam 500 while the shaft 200 of the regulator apparatus R rotates.

The ticker 400 according to an embodiment of the present disclosure will be described with reference to FIGS. 17 and 18.

The regulator apparatus may include the ticker 400.

The ticker 400 may be positioned between the case cover 110 and the cam 500. The ticker 400 may be coupled to the case cover 110. The ticker 400 may be coupled to a rear surface of the case cover 110.

The ticker 400 may include a ticker protrusion 410. The ticker protrusion 410 may protrude toward the cam 500. A width of an end of the ticker protrusion 410 may be smaller than or equal to a width of the concave portion 530 of the cam 500.

The ticker 400 may include a ticker protrusion support 420. The ticker protrusion support 420 may extend from the thicker protrusion 410. The thicker protrusion support 420 may extend in a left-right direction or an up-down direction.

A plurality of ticker protrusion supports 420 may be provided. One of the plurality of ticker protrusion supports 420 may extend from one end of the ticker protrusion 410. Another one of the plurality of thicker protrusion supports 420 may extend from another end of the ticker protrusion 410 in an opposite direction of a direction in which the one of the ticker protrusion supports 420 extends.

The ticker 400 may include a ticker support 430. The ticker support 430 may be located between the ticker protrusion support 430 and the case 100. The ticker support 430 may extend from the ticker protrusion support 430. The ticker support 430 may extend in the front direction. The ticker support 430 may extend in the front direction, be bent, and extend in a direction that is parallel to a direction in which the rear surface of the case cover 110 extends.

The ticker protrusion 410 may be rested in a ticker (400) accommodating groove defined by the concave portion 530.

While the cam 500 rotates according to a rotation of the shaft 200, the ticker protrusion 410 may be rested on the convex portion 520. In this case, the ticker protrusion 410 may move away from the cam 500. The ticker protrusion 410 may move in the front direction. While the ticker protrusion 410 moves, the ticker 400 may be elastically deformed. The ticker 400 may have elasticity to return to an original shape according to deformation.

While the cam 500 rotates further, the ticker protrusion 410 may be rested on another concave portion 530 adjacent to the convex portion 520. That is, the ticker protrusion 410 may be rested in another ticker (400) accommodating groove. In this case, the ticker 400 may receive a force to return to the original shape. The ticker protrusion 410 may move toward the concave portion 530, and accordingly, when the ticker protrusion 410 contacts the concave portion 530, a sound and vibration may be generated. Therefore, a user may recognize that the cam 500 has rotated.

While the user rotates the knob N1, the user may recognize a sound and vibration generated when the ticker protrusion 410 contacts the concave portion 530, and recognize pressure transferred to the ticker protrusion 410 when the ticker protrusion 410 moves while being in contact with the convex portion 520, thereby recognizing the rotation of the knob N1.

In other words, the cam 500 may include the cam body 510, the convex portion 520 protruding from the cam body 510, and the concave portion 530 that is concave from the cam body 510 and defines the ticker (400) accommodating groove.

The ticker 400 may be located between the case 100 and the cam 500. The ticker 400 may be accommodated in the ticker (400) accommodating groove and come into contact with the convex portion 520 according to a rotation of the cam 500 to generate vibration according to the rotation of the cam 500.

In an embodiment of the present disclosure, by placing only a pair of electrodes, one kind of signal may be generated according to a rotation of the cam 500. However, by providing several pairs of electrodes and a plurality of pressing ribs 540 corresponding to the several pairs of electrodes, different signals may be generated according to degrees of rotation of the cam 500.

Hereinafter, a process of generating a signal in the regulator apparatus R according to a rotation of the cam 500 will be described.

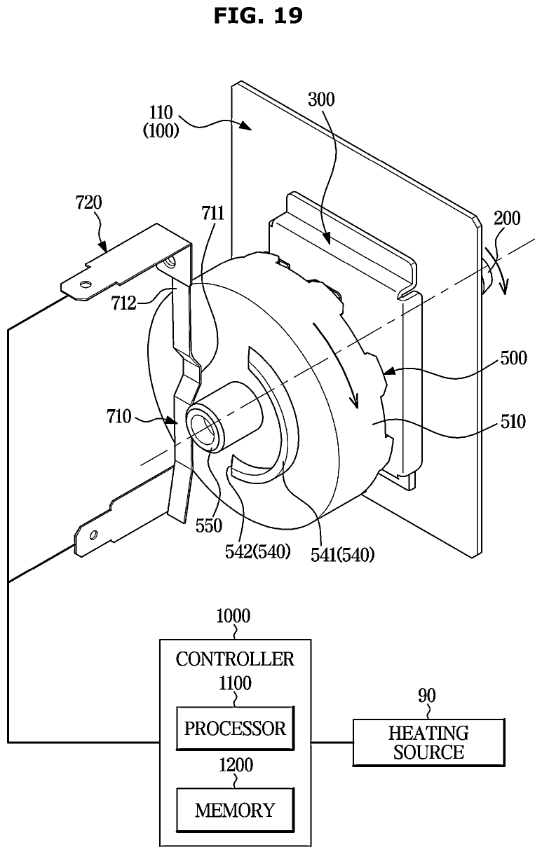

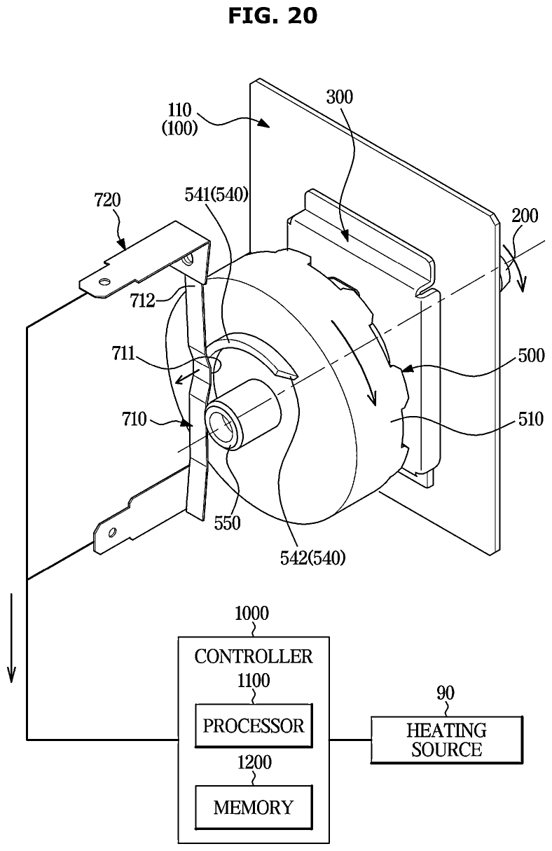

FIG. 19 is a rear perspective view of the regulator apparatus R shown in FIG. 18 when the first electrode is spaced apart from the second electrode while the shaft 200 of the regulator apparatus R rotates. FIG. 20 is a rear perspective view of the regulator apparatus R shown in FIG. 19 when the first electrode comes into contact with the second electrode while the shaft 200 of the regulator apparatus R rotates.

An operation of generating a signal according to a rotation of the cam 500 according to an embodiment of the present disclosure will be described with reference to FIGS. 19 and 20.

The regulator apparatus R may include the shaft 200 and the cam 500.

While the shaft 200 is located at the second position P2, the cam 500 may rotate according to a rotation of the shaft 200.

The cam 500 may include the pressing rib 540 on the side toward the case body 120.

The pressing rib 540 may extend in the circumferential direction around the rotation axis of the cam 500.

The pressing rib 540 may include a rib body 541. The rib body 541 may be a component that defines at least a part of an appearance of the pressing rib 540.

The pressing rib 540 may include a rib slope 542. The rib slope 542 may be inclined in such a way as to get closer to a cam (500) body toward a direction in which the rib body 541 extends at one end of the rib body 541. The rib slope 542 may be configured such that the terminal 700 easily moves on the rib slope 542 while being in contact with the rib slope 542.

A pair of terminals 700 may be provided. The pair of terminals 700 may include a first terminal 710 and a second terminal 720.

The second terminal 720 may be fixed to the case body 120. One end of the first terminal 710 may be coupled to the case body 120, and another end may be a free end 712. The first terminal 710 may have a linear shape.

The first terminal 710 may include a terminal protrusion 711 protruding toward the cam 500 between the one end and the other end.

The terminal protrusion 711 may be located on a trajectory drawn by the pressing rib 540 while the cam 500 rotates.

While the terminal protrusion 711 does not contact the pressing rib 540, the first terminal 710 may be spaced from the second terminal 720.

While the cam 500 rotates, the terminal protrusion 711 may contact the rib slope 542 of the pressing rib 540.

According to a further rotation of the cam 500, the terminal protrusion 711 may pass the rib slope 542 and contact the rib body 541. Therefore, the first electrode may contact the second electrode.

According to a further rotation of the cam 500, the terminal protrusion 711 may be spaced from the pressing rib 540. In this case, the terminal protrusion 711 may contact the cam (500) body.

In other words, according to a rotation of the cam 500, the pressing rib 540 may spin, and according to spinning of the pressing rib 540, the first terminal 710 may be pressed to contact the second terminal 720.

In other words, the cam 500 may include the pressing rib 540 extending in a circumferential direction around the rotation axis of the cam 500.

According to a rotation of the cam 500, the first terminal 710 may be pressed

by the pressing rib 540 and at least a part of the first terminal 710 may move.

The second terminal 720 may contact the first terminal 710 moved and carry electricity to enable the regulator apparatus R to detect a user input.

The cooking apparatus 1 may include a controller 1000.

The controller 1000 may include a processor 1100 and a memory 1200.

The processor 1100 may include a program (a plurality of instructions) for processing a signal and providing a control signal.

The memory 1200 may include a volatile memory 1200, such as Static Random Access Memory (S-RAM) and Dynamic Random Access Memory (D-RAM), and a non-volatile memory 1200, such as Read Only Memory (ROM) and Erasable Programmable Read Only Memory (EPROM).

The memory 1200 may be integrated into the processor 1100 or provided as a semiconductor device separated from the processor 1100.

The processor 1100 may further include a processing core (for example, a memory circuit and a control circuit) that processes a signal based on a program or data stored in the memory 1200 and outputs a control signal.

While the first terminal 710 contacts the second terminal 720, the regulator apparatus R may generate a signal that is received by the processor 1100.

The processor 1100 may control the heating source 90 such that the heating source 90 operates based on a user input detected by the regulator apparatus R.

The processor 1100 may control the heating source 90 to operate the heating source 90 based on a signal generated by the regulator apparatus R in correspondence to a user input.

So far, the regulator apparatus R according to an embodiment of the present disclosure and the cooking apparatus 1 including the regulator apparatus R have been described.

Hereinafter, another embodiment will be described. In the following description about the other embodiment, the same components as those shown in FIGS. 1 to 20 will be assigned the same reference numerals, and descriptions thereof will be omitted.

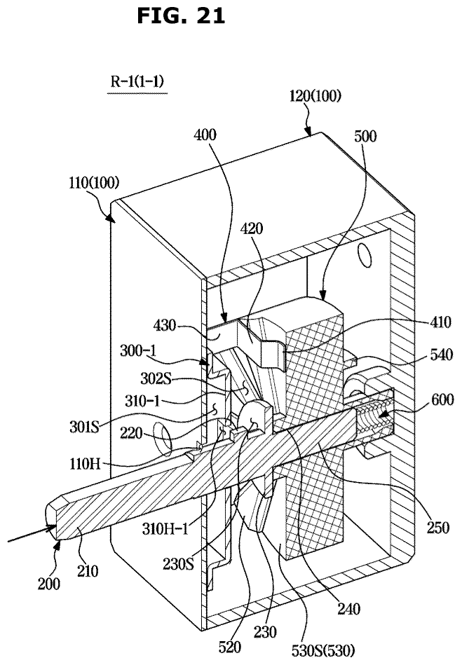

FIG. 21 is a cross-sectional perspective view of a regulator apparatus R-1 of a cooking apparatus 1-1 according to an embodiment of the present disclosure.

The regulator apparatus R-1 according to an embodiment of the present disclosure will be described with reference to FIG. 21.

The regulator apparatus R-1 may include an operation prevention member 300-1.

The operation prevention member 300-1 may include a stopper hole 310H-1.

The stopper hole 310H-1 may be aligned in a direction that is parallel to the stopper groove 110H and the rotation axis of the shaft 200.

The stopper hole 310H-1 may have a larger cross section than the stopper groove 110H. Therefore, the stopper 220 may more easily penetrate the stopper hole 310H-1 than in the case in which the stopper hole 310H-1 has the same cross section as that of the stopper groove 110H.

In other words, the stopper hole 310H-1 may have a larger cross section than the stopper groove 110H such that the stopper 220 penetrates the stopper hole 310H-1 even though the shaft 200 rotates a little about the rotation axis while moving from the first position P1 toward the second position P2.

The stopper groove 110H may have a shape corresponding to the stopper 220 to limit a spinning motion of the stopper 220 to limit a rotational motion of the shaft 200. In the case in which a user presses the shaft 200 in the normal direction D1, the user may rotate the shaft 200 due to his/her hand shaking, etc. while moving the shaft 200 in the normal direction D1. In the case in which the stopper hole 310H-1 has a shape completely corresponding to the stopper 220, the stopper 220 may fail to penetrate the stopper hole 310H-1 according to a user's intention, which may cause the user's convenience.

According to the stopper hole 310H-1 being larger than the stopper groove 110H, even though a user rotates the shaft 200 a little while operating the shaft 200, the shaft 200 may move to the second position P2.

According to the cross section of the stopper 220 having a substantially rectangular shape, the stopper 220 may have corners corresponding to an upper end and both sides.

A cross section of the stopper groove 110H may also have corners of an upper end and corners of both sides to correspond to the corners of the stopper 220.

A cross section of the stopper hole 310H-1 may have corners of an upper end located at an upper location than the corners of the upper end of the first stopper 220 and corners of both sides located to be further away from each other than the corners of the both sides of the first stopper 220.

In the present embodiment, the stopper hole 310H-1 may have a larger size than the corresponding one in the embodiment described with reference to FIGS. 1 to 20.

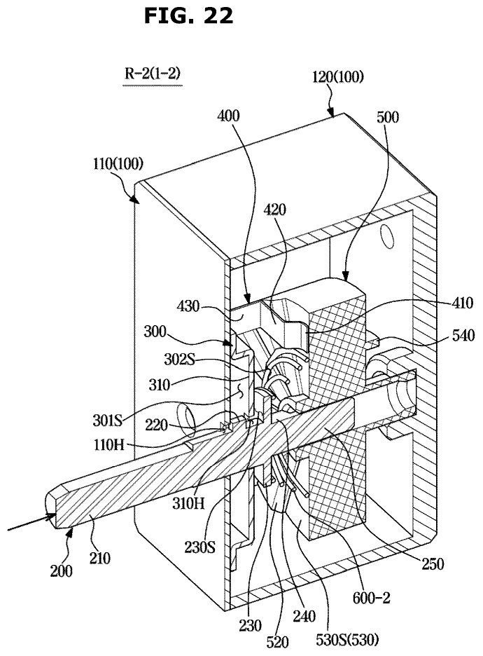

FIG. 22 is a cross-sectional perspective view of a regulator apparatus R-2 of a cooking apparatus 1-2 according to an embodiment of the present disclosure.

The regulator apparatus R-2 according to an embodiment of the present disclosure will be described with reference to FIG. 22.

The regulator apparatus R-2 may include an elastic member 600-2.

The elastic member 600-2 may be located between the cam 500 and the shaft 200. The elastic member 600-2 may be located between a part of the cam 500 where the concave portion 530 and the convex portion 520 are located and the shaft flange 230 of the shaft 200. The elastic member 600-2 may be located between a front side of the cam 500 and a rear side of the shaft flange 230.

A cross sectional area of the elastic member 600-2 may be reduced toward the front direction. Therefore, according to compression of the elastic member 600-2, a width of the elastic member 600-2 may be reduced, although not limited thereto. However, the cross sectional area of the elastic member 600-2 may be reduced toward the rear direction.

Unlike this, in the case in which the cross sectional area of the elastic member 600-2 is constant in the front-rear direction, the elastic member 600-2 may have a preset width even when the elastic member 600-2 is compressed. In the case in which the elastic member 600-2 has a large width even when the elastic member 600-2 is compressed, the stopper 220 may be limited in being located in the operation space 302S. Accordingly, the shaft 200 may be limited in rotating together with the cam 500.

In other words, the elastic member 600-2 may be located between the shaft 200 and the cam 500 to press the shaft 200 from the second position P2 toward the first position P1. The cross sectional area of the elastic member 600-2 may be reduced in a direction that is parallel to the rotation axis of the shaft 200 such that, while the elastic member 600-2 is compressed, the cam 500 moves close to the operation prevention member 300.

In the present embodiment, the position and shape of the elastic member 600-2 may be different from the corresponding ones in the embodiment described with reference to FIGS. 1 to 20.

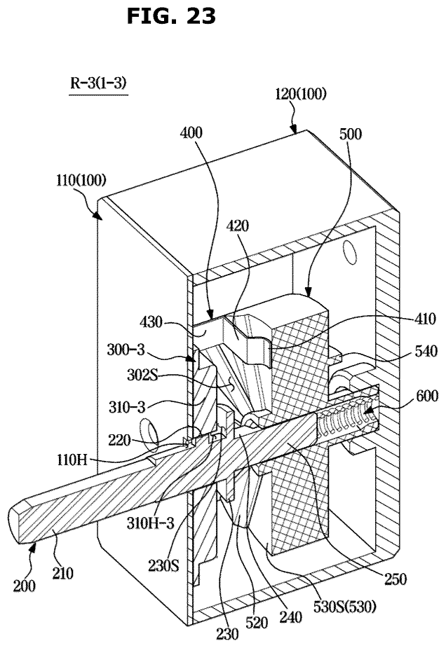

FIG. 23 is a cross-sectional perspective view of a regulator apparatus R-3 of a cooking apparatus 1-3 according to an embodiment of the present disclosure.

The regulator apparatus R-3 according to an embodiment of the present disclosure will be described with reference to FIG. 23.

The regulator apparatus R-3 may include an operation prevention member 300-3.

The operation prevention member 300-3 may include a stopper plate 310-3.

The stopper plate 310-3 may be adjacent to the case cover 110.

A stopper hole 310H-3 located in the stopper plate 310-3 may communicate with the stopper groove 110H.

The stopper hole 310H-3 may be adjacent to the rear opening of the stopper groove 110H.

While the shaft 200 is at the operation prevention position P, the stopper 220 may be accommodated in the stopper hole 310H-3. Therefore, the stopper 220 may be prevented from rotating. Because the stopper 220 is prevented from rotating, the shaft 200 may be prevented from rotating.

In FIG. 23, the cylindrical portion 250 of the shaft 200 is shown. However, the present disclosure is not limited thereto, and the rotation prevention portion 240 may extend up to the cylindrical portion 250 of the shaft 200. Accordingly, the rotation prevention portion accommodating space 510aS may extend up to the cylindrical portion accommodating space 510bS in which the cylindrical portion 250 is accommodated. The reason may be because idling of the shaft 200 is not required.

While the stopper 220 passes through the stopper groove 110H and the stopper hole 310H-3 and is located in the operation space 302S, a user may need to press the shaft 200 in order to rotate the shaft 200. Accordingly, the user will intentionally press the shaft 200.

In other words, the stopper plate 310-3 may be located adjacent to the stopper groove 110H. The stopper plate 310-3 may have the stopper hole 310H-3 extending in the direction that is parallel to the rotation axis of the shaft 200 to accommodate the stopper 220 while the shaft 200 is at the operation prevention position P.

The present embodiment may be different from the embodiment described with reference to FIGS. 1 to 20 in view of presence or absence of the operation prevention space 301S and a positional relationship between the stopper plate 310-3 and the stopper hole 310H-3.

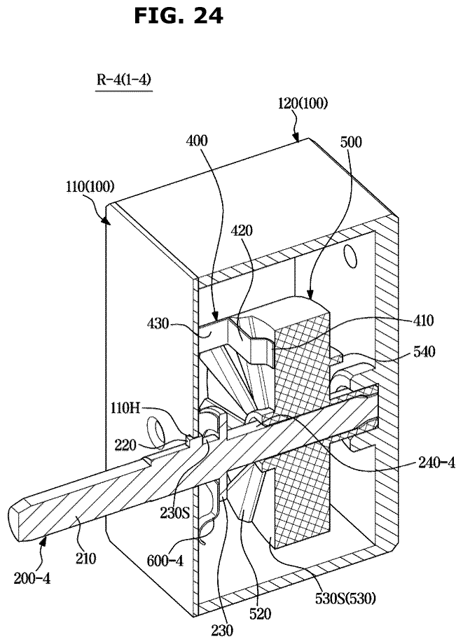

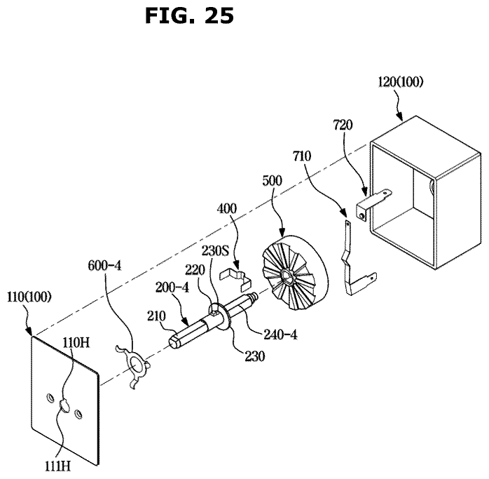

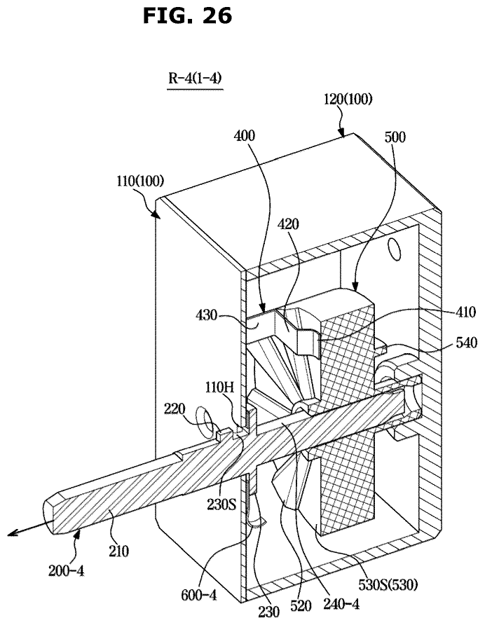

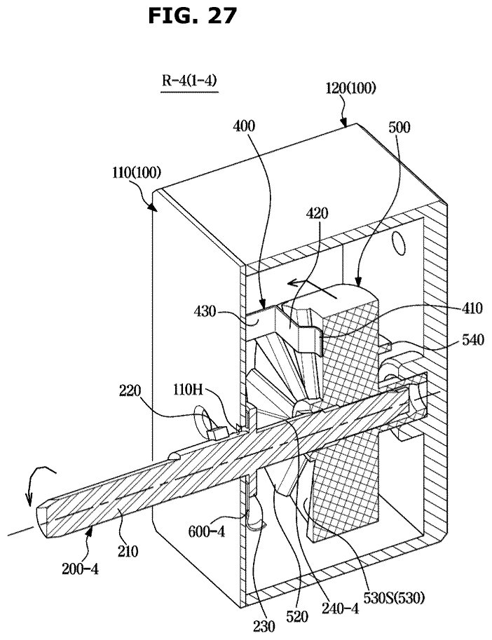

FIG. 24 is a cross-sectional perspective view of a regulator apparatus R-4 of a cooking apparatus 1-4 according to an embodiment of the present disclosure. FIG. 25 is an exploded view of the regulator apparatus R-4 shown in FIG. 24. FIG. 26 is a cross-sectional perspective view of the regulator apparatus R-4 shown in FIG. 24 while a shaft 200-4 of the regulator apparatus R-4 is pulled. FIG. 27 is a cross-sectional perspective view of the regulator apparatus R-4 shown in FIG. 26 while the shaft 200-4 of the regulator apparatus R-4 rotates.

The regulator apparatus R-4 according to an embodiment of the present disclosure will be described with reference to FIGS. 24 to 27.

The regulator apparatus R-4 may include the case 100.

The case 100 may include the case body 120 and the case cover 110 in which the stopper groove 110H is located. The stopper groove 110H may be located in the case cover 110.

The regulator apparatus R-4 may include the shaft 200-4.

The shaft 200-4 may include the shaft body 210 and the stopper 220 protruding from the shaft body 210.

The shaft 200-4 may include a stopper (220) flange that is spaced from the stopper 220 and defines the plate accommodating space 230S.

The shaft 200-4 may include a rotation prevention portion 240-4 that is accommodated in the cam 500.

The shaft 200-4 may include the shaft body 210 of which at least a part is inserted into the case 100. The shaft 200-4 may include the stopper 220 that protrudes from the shaft body 210 and is accommodated in the stopper groove 110H while the shaft 200-4 is located at a first position P1.

The shaft 200-4 may move to a second position P2 at which the stopper 220 is spaced an operation distance L2 from the stopper groove 110H.

While the shaft 200-4 moves from the first position P1 to the second position P2, the shaft 200-4 may move outward from the case 100.

The shaft 200-4 may include the shaft flange 230 that protrudes in a radial direction from the shaft body 210 and comes into contact with the case cover 110 while the shaft 200-4 is at the second position P2 to prevent the shaft 200-4 from departing from the case 100.

The regulator apparatus R-4 may include the cam 500.

The cam 500 may include the cam body 510 having the rotation prevention portion accommodating space 510aS. In the present embodiment, while the shaft 200-4 rotates, the cam 500 may rotate together.

The cam 500 may include the cam body 510, the convex portion 520, the concave portion 530, and the pressing rib 540.

The cam 500 may be adjacent to the shaft 200-4 such that the shaft 200-4 is inserted into the cam 500. The cam 500 may be configured to rotate together with the shaft 200-4 to enable the regulator apparatus R-4 to detect a user input.

The regulator apparatus R-4 may include the terminal 700 including the first terminal 710 and the second terminal 720. The first terminal 710 may contact the first terminal 720 by a rotation of the cam 500. Accordingly, the first terminal 710 may generate an electrical signal.

The regulator apparatus R-4 may include the ticker 400. The ticker 400 may allow a user to feel a sense of operation on the knob N1 by contacting the convex portion 520 or the concave portion 530 of the cam 500 according to a rotation of the cam 500.

An elastic member 600-4 may be located on the rear surface of the case cover 110. The elastic member 600-4 may press the shaft 200-4 toward the rear direction.

The elastic member 600-4 may be located between the flange shaft 200-4 and the case cover 110.

The elastic member 600-4 may include a plate spring.

The elastic member 600-4 may have a hole which the shaft 200-4 penetrates.

The elastic member 600-4 may extend along the extension direction of the shaft flange 230 from the hole which the shaft 200-4 penetrates.

The elastic member 600-4 may be in contact with the case cover 110.

The shaft 200-4 may be located at the first position P1 at which the stopper 220 is accommodated in the stopper groove 110H.

The shaft 200-4 may be located at the second position P2 at which the stopper 220 has been moved outward from the case 100. While the stopper 220 moves outward from the case 100, the stopper 220 may depart from the stopper groove 110H. The shaft 200-4 may move in the front direction to move from the first position P1 to the second position P2.

While the shaft 200-4 is at the second position P2, the shaft 200-4 may rotate. The reason may be because the stopper 220 has departed from the stopper groove 110H.

While the shaft 200-4 is at the second position P2 and rotates, the cam 500 may rotate.

The stopper 220 may move from a first spin position at which the stopper 220 is accommodated in the stopper groove 110H to a second spin position at which the stopper 220 has spined.

While the shaft 200-4 is at the second position P2, the stopper 220 may spin around the rotation axis of the shaft 200-4 outside the case 100.

While the cam 500 rotates, the first electrode may contact the second electrode and the regulator apparatus R-4 may generate a signal.

While the shaft 200-4 rotates, the stopper 220 may be located at the second spin position to contact a front surface of the case cover 110. In this case, the stopper 220 may be limited in moving in the rear direction by the case cover 110, and accordingly, the shaft 200-4 may be prevented from moving in the rear direction.

According to the shaft flange 230 coming into contact with the case cover 110, the shaft 200-4 may be limited in moving in the front direction. Therefore, the shaft 200-4 may be prevented from departing from the case 100.

While the stopper 220 moves from the second spin position to the first spin position, the stopper 220 may move to be accommodated in the stopper groove 110H. According to the movement of the stopper 220, the shaft 200-4 may move in the rear direction.

The stopper 220 may be spaced from the shaft flange 230 to define the plate accommodating space 230S that accommodates the case cover 110, between the stopper 220 and the shaft flange 230, while the shaft 200-4 is at the second position P2 and the stopper 220 spins.

The rotation prevention portion 240-4 of the shaft 200-4 may face an inner side of the case body 120. While the shaft 200-4 moves from the first position P1 in the rear direction, the rotation prevention portion 240-4 may come into contact with the inner side of the case body 120. Therefore, the shaft 200-4 may be limited in moving in the rear direction. Accordingly, the shaft 200-4 may be prevented from departing from the case 100.

For the regulator apparatus R to generate a signal corresponding to a user input, the shaft 200-4 may need to move in the front direction and rotate. A user may implement a forward movement and rotational movement of the shaft 200-4 by pulling and turning the knob N1. Because the user's action of pulling the knob N1 will be an intentional action, according to the present disclosure, the regulator apparatus R-4 may generate a signal only depending on a user's intention.

The present embodiment may be different from the embodiment described with reference to FIGS. 1 to 20 in that the regulator apparatus R-4 generates a signal when a user pulls and turns the shaft 200-4.

The above-described embodiments can be combined with other embodiments unless clearly indicated otherwise. Alternatively, the embodiments can be combined with each other unless there are obvious limitations. Combinations of any embodiment and the other embodiments are considered to be disclosed in the present document.

So far, specific embodiments have been shown and described. However, the disclosure is not limited to the above-described embodiments, and various modifications can be made by one of ordinary skill in the technical art to which the present disclosure belongs without departing from the gist of the technical idea of the disclosure defined by the claims below.

1. A cooking apparatus, comprising:
a heating source; and
a regulator apparatus configured to detect a user input to operate the heating source,
wherein the regulator apparatus comprises:
a case including a stopper groove;
a shaft including a shaft body having at least a part insertable in the case, the shaft including a stopper protruding from the shaft body and configured to be accommodated in the stopper groove while the shaft is inserted in the case and located at a first position, the stopper being movable to a second position spaced at an operation distance from the stopper groove and an operation prevention position spaced an operation prevention distance from the stopper groove, the operation prevention distance being shorter than the operation distance;
a cam arrangeable to be adjacent to the shaft such that the shaft is insertable into the cam, the cam while adjacent to the shaft the cam being configured to rotate together with the shaft while the shaft is inserted into the cam and the shaft is at the second position, thereby enabling the regulator apparatus to detect the user input; and
an operation prevention member to be located between the cam and the stopper groove, wherein, while the shaft is at the operation prevention position, the stopper is located on an inner side of the operation prevention member to prevent the shaft from moving from the operation prevention position to the second position to prevent the cam from rotating by the shaft.

2. The cooking apparatus of claim 1, wherein
the operation prevention member includes a stopper hole which the stopper penetrates to allow the shaft to move from the operation prevention position to the second position.

3. The cooking apparatus of claim 1, wherein
the case includes a case cover in which the stopper groove is located,
the operation prevention member includes a stopper plate spaced from the case cover to form an operation prevention space, and
the stopper is located in the operation prevention space while the shaft is at the operation prevention position.

4. The cooking apparatus of claim 3, wherein
the stopper is configured to spin around a rotation axis of the shaft inside the operation prevention space while the shaft is at the operation prevention position.

5. The cooking apparatus of claim 3, wherein
the cam is configured to, while the shaft is at the operation prevention position, be prevented from rotating together with the shaft to prevent the regulator apparatus from detecting the user input, and
the stopper plate includes a stopper hole which the stopper penetrates to allow the shaft to move from the operation prevention position to the second position, and
while the shaft rotates about a rotation axis while at the operation prevention position, the stopper is misaligned with a position corresponding to the stopper hole and comes into contact with the stopper plate to prevent the shaft from moving to the second position.

6. The cooking apparatus of claim 2, wherein
the stopper hole is aligned with the stopper groove in a direction that is parallel to a rotation axis of the shaft, and
a cross section of the stopper hole is larger than a cross section of the stopper groove allowing the stopper to penetrate the stopper hole while the shaft rotates about the rotation axis while the shaft moves from the first position toward the second position.

7. The cooking apparatus of claim 1, further comprising
a processor configured to control the heating source such that the heating source operates based on the user input that is detected by the regulator apparatus,
wherein the cam comprises a pressing rib extending in a circumferential direction around a rotation axis of the cam, and
the regulator apparatus comprises:
a first terminal having at least a part movable by being pressed by the pressing rib while the cam rotates; and
a second terminal configured to carry electricity by contacting the first terminal moved to enable the regulator apparatus to detect the user input.

8. The cooking apparatus of claim 3, wherein
the shaft further comprises a shaft flange protruding in a radial direction from the shaft body and configured to contact the stopper plate while the shaft moves from the second position toward the first position, thereby preventing the shaft from departing from the case.

9. The cooking apparatus of claim 8, wherein
the stopper is spaced from the shaft flange to form a plate accommodating space between the stopper and the shaft flange, and
the stopper plate is accommodated in a stopper accommodating space while the shaft is at the operation prevention position and the stopper spins, thereby being prevented from interfering with a rotation of the shaft.

10. The cooking apparatus of claim 2, wherein
the shaft comprises a cylindrical portion located at an end toward the cam and configured to be accommodated in the cam in such a way as to rotate independently from the cam while the shaft is at the operation prevention position.

11. The cooking apparatus of claim 10, wherein
the shaft comprises a rotation prevention portion being adjacent to the cylindrical portion and being rotationally asymmetrical to a rotation axis of the shaft, and
the rotation prevention portion is accommodated in the cam while the shaft is at the second position to rotate together with the cam.

12. The cooking apparatus of claim 10, further comprising
an elastic member accommodated in the cam and configured to press the shaft in a direction from the second position toward the first position.

13. The cooking apparatus of claim 1, wherein
the cam further comprises:
a cam body;
a convex portion protruding from the cam body;
a concave portion being concave from the cam body and defining a ticker accommodating groove; and
a ticker located between the case and the cam, being accommodable in the ticker accommodating groove, and contacting the convex portion according to a rotation of the cam to generate vibration according to the rotation of the cam.

14. The cooking apparatus of claim 1, wherein
the operation prevention member comprises a stopper plate located adjacent to the stopper groove, the stopper plate including a stopper hole extending in a direction parallel to a rotation axis of the shaft and configured to accommodate the stopper while the shaft is at the operation prevention position.

15. The cooking apparatus of claim 1, further comprising:
an elastic member located between the shaft and the cam and configured to press the shaft in a direction from the second position toward the first position, wherein a cross sectional area of the elastic member is reduced in the direction parallel to a rotation axis of the shaft such that the cam moves close to the operation prevention member according to compression of the elastic member.
